(19) United States
(12) Patent Application Publication
(10) Pub. No.: US 2004/0090964 A1
(43) Pub. Date: May 13, 2004

(54) Means and apparatus for a scaleable congestion free switching system with intelligent control II

(76) Inventors: Coke Reed, Princeton, NJ (US); David Murphy, Austin, TX (US)

Correspondence Address: DICKSTEIN SHAPIRO MORIN & OSHINSKY LLP, 1177 AVENUE OF THE AMERICAS, NEW YORK, NY, 10038-2714, US

(21) Appl. No.: 10/289,902

(22) Filed: Nov. 7, 2002

(51) Int. Cl. H04L 12/56

(52) U.S. Cl. 370/395.4; 370/230

(57) ABSTRACT

An interconnect structure having a plurality of input ports and a plurality of output ports, including an input controller which requests permission from predetermined logic within the structure to inject an entire message through two stages of data switches. The request contains only a portion of the address for a message target output with the amount of target output addresses supplied by the input controller depending upon the data rate of the target output port.

### RELATED PATENT AND PATENT APPLICATIONS

The disclosed system and operating method are related to subject matter disclosed in the following patents and patent applications that are incorporated by reference herein in their entirety:

1. U.S. Pat. No. 5,996,020 entitled, “A Multiple Level Minimum Logic Network”, naming Coke S. Reed as inventor;

2. U.S. Pat. No. 6,289,021 entitled, “A Scaleable Low Latency Switch for Usage in an Interconnect Structure”, naming John Hesse as inventor;

3. U.S. patent application Ser. No. 09/693,359 entitled, “Multiple Path Wormhole Interconnect”, naming John Hesse as inventor;

4. U.S. patent application Ser. No. 09/693,357 entitled, “Scalable Wormhole-Routing Concentrator”, naming John Hesse and Coke Reed as inventors;

5. U.S. patent application Ser. No. 09/693,603 entitled, “Scaleable Interconnect Structure for Parallel Computing and Parallel Memory Access”, naming John Hesse and Coke Reed as inventors;

6. U.S. patent application Ser. No. 09/693,358 entitled, “Scalable Interconnect Structure Utilizing Quality-Of-Service Handling”, naming Coke Reed and John Hesse as inventors;

7. U.S. patent application Ser. No. 09/692,073 entitled, “Scalable Method and Apparatus for Increasing Throughput in Multiple Level Minimum Logic Networks Using a Plurality of Control Lines”, naming Coke Reed and John Hesse as inventors;

8. U.S. patent application Ser. No. 09/919,462 entitled, “Means and Apparatus for a Scaleable Congestion Free Switching System with Intelligent Control”, naming John Hesse and Coke Reed as inventors;

9. U.S. patent application Ser. No. 10/123,382 entitled, “A Controlled Shared Memory Smart Switch System”, naming Coke S. Reed and David Murphy as inventors.

### RELATED PUBLICATION

McKeown, Nick, “The iSLIP Scheduling Algorithm for Input-Queued Switches”, IEEE Transactions on Networking Vol. 7, No. 2, April 1999.

### FIELD OF THE INVENTION

The present invention relates to a method and means of controlling an interconnect structure applicable to voice and video communication systems, to data/Internet connections, and to various other applications, including computing and entertainment.

### BACKGROUND OF THE INVENTION

In a number of computing, entertainment and communication systems, the movement of data is the crucial limiting factor in performance. In the areas of data movement, switching and management, the referenced patents represent a substantial advance over the prior art. The referenced patents are all incorporated by reference and are the foundation of the present invention. The present invention is a continuation in part of patent No. 8, “Means and Apparatus for a Scaleable Congestion Free Switching System with Intelligent Control”, naming John Hesse and Coke Reed as inventors. The present invention is also a continuation in part of invention No. 9, “A Controlled Shared Memory Smart Switch System”, naming Coke S. Reed and David Murphy as inventors. The present invention is assigned to the same entity as inventions No. 8 and No. 9.

Inventions 8 and 9 represent many advances over the prior art including the scheduling messages with different levels of quality of service. In invention number eight, schedules messages to enter an interconnect structure with the scheduling of messages based on quality of service. By contrast, the iSLIP algorithm of the related publication, is not able to schedule entire messages but only segments of those messages. Moreover, in some instances the iSLIP algorithm schedules lower priority messages from an input port that contains higher priority messages. This occurs when granted requests are not accepted. By contrast, in invention number 8 all granted requests are accepted. Moreover, in contrast to invention 8, the iSLIP algorithm in conjunction with a crossbar switch is not scalable. Invention 8 had the ability to schedule entire message packets rather than merely schedule message segments, the present invention sets aside a special location in memory to receive these messages. This bin reservation relieves the output port of the responsibility of segment reassembly.

It is, therefore, an object of the present invention to utilize the referenced inventions to create a scaleable, congestion free, low latency switching system with intelligent control, which can be used in a large number of products, including products in the computing, communication and entertainment fields.

In a number of applications, switching systems have I/O ports of varying bandwidth capacity. A first such application is an access switch, which receives input data from and sends output data to a number of personal computers and workstations at one data rate and also receives data from and sends data to a number of higher data rate devices. These high data rate devices may include higher data rate servers, higher data rate routers, and main frame computers or supercomputers. Such systems can be used in a wide range of applications including cluster computing. A second such application is a core edge router, which has a number of very high data rate I/O ports from high end servers or other devices as well as a number of ultra high data core lines.

It is, therefore, an object of the present invention to provide a controlled, low latency, packet switching system supporting a plurality of I/O devices of various data rate capacity.

In router applications employing line cards, it is an object of the present invention to eliminate some of the tasks of the line cards in the prior art, thereby decreasing the cost of the line cards and, consequently, greatly decreasing the cost of the entire routing system.

It is a further object of the present invention to provide an efficient method of segmentation and reassembly of packets within the switching system with intelligent control. Thereby, the present invention relieves the line cards of that function.

It is a further object of the present invention to provide an efficient method of communication between a number of computational elements, which may reside in supercomputing environments, in distributed cluster computing environments, in storage area networks, or in environments containing various computational devices. The latter set of devices may include clusters of workstations, supercomputers, data base computers, or special purpose computers. Some or all of the computing devices may be constructed using the novel computation memory capacity described in referenced patent No. 5, entitled “Scaleable Interconnect Structure for Parallel Computing and Parallel Memory Access”.

It is a further object of the present invention to provide an efficient method of segmentation and reassembly of messages in conjunction with multicasting.

It is a further object of the present invention to reduce or eliminate sub-segmenting of packets in systems employing parallel data switches. This improvement allows for increased throughput in parallel data switches without lowering the data/header ratio for data passing through a given switch in the stack of data switches.

### SUMMARY OF THE INVENTION

This patent extends, generalizes and improves the referenced patents in a number of ways. In particular, it extends the referenced patent No. 8, “Means and Apparatus for a Scaleable Congestion Free Switching System with Intelligent Control”. Important improvements are made possible by: 1) the expanded functions of the request processors RP₀, RP₁, . . . , RP_{N-1}; 2) the subdividing of the output buffers into bins and 3) the inclusion of the additional data switch DS2 and, in some embodiments, by the inclusion of an additional answer switch AS2.

In patent No. 8, the input controllers made a request to inject a single message packet segment into a single data switch. The request packet specified the address of the target output. The request processor receiving the request had the ability to schedule a time for the sending of the entire packet through the data switch. The segments were sent through the data switch and arrived in order at an output device. In one embodiment of the present invention, the input controller requests permission to inject an entire message through two stages of data switches. The request packet contains only a portion of the message target output with the amount of target output address supplied by the input controller depending upon the data rate of the target output port. In response to the request, the request processor returns an answer that contains several data fields which may include: 1) the time for the input controller to begin injecting the entire message into the data switch; 2) the specification of one of a plurality of paths to be followed by the message packet traveling from an I/O device to the data switch, thereby providing a target input port into the first data switch; and 3) the specification of the remainder of the target address. This last specification may include the address of the target output level of a first data switch as well as the output port of a second data switch. The output port of the second data switch is connected to a transmission line that sends data from the second data switch to a data bin reserved for the message.

The input/output devices may be line cards connected to an Internet switch or they may be interfaces to processing elements in a parallel computing environment. They may have a means of converting optical data input to electronic signals as well as a means of converting outgoing data from electronics to optics. They may also have the capability of making the lookup functions to determine the proper output port for an arriving message. The line cards may also support inputs and outputs of different data rates of different formats.

The input controllers have buffers that are capable of containing a number of incoming data packets. The input controllers communicate with the request processors, perform segmentation of the messages, and direct messages from the I/O devices to the data switches. Each data packet sent through the data switches is sent at a prescheduled time and arrives at an output controller at a prescheduled time. Moreover, each segment of the data packet is sent to a prescheduled data storage bin. One consequence of sending the segments to a pre-scheduled data storage bin is to achieve efficient reassembly of the data packet.

Input Controllers, Output Controllers & Request Processors

A message packet entering the system at a given I/O device is sent through the system to its targeted I/O device. In Internet applications, the I/O devices are line cards. When a message packet M arrives at the system it enters a line card. It is an important function of the line card to ascertain the targeted output line card for M. Each system I/O device sends incoming messages to an input controller and receives outgoing messages from an output controller. The input controller sends an incoming message to an output controller associated with the message's targeted I/O device. The output controller subsequently forwards that message to the targeted I/O device. The message is sent through a data switch from the input controller to the output controller at a time scheduled by a request processor associated with the message's target output controller. Therefore, associated with each message that passes through the system, there is an input controller that receives the message from an I/O device and a request processor (associated with the message's targeted output controller) that schedules the movement of the message through the system to an output controller that passes the message to its targeted I/O device.

An output controller contains buffers for storing messages received from the data switch. These buffers are divided into sub-buffers referred to as bins. All segments of a given packet are placed in the same bin. One of the functions of a request processor is to assign a bin address to each packet. The segments of each packet are placed into the bins in the proper sequential order. Therefore, reassembly of the segments into a packet is performed by the output controller rather than by a line card or other I/O device. A central theme of the present invention is that some of the I/O devices receive data at a higher data rate than other I/O devices. Output controllers associated with higher data rate devices are designed with more buffer storage and, hence, with a larger number of bins.

A message packet MA arrives at an I/O device of the system and is targeted to exit the system at another I/O device of the system. An input controller associated with the input I/O device is responsible for inserting MA into the system data switch. The input controller asks the request processor associated with the targeted output of MA to schedule a time interval for the input controller to inject the message packet segments of MA into the data switch. During the request cycle, MA is stored in a buffer that is located either in the I/O device or in the input controller. The request processor either rejects the request to inject MA into the data switch or it chooses a time interval for the request processor to inject MA into the data switch. The input controller must have an available input line into the data switch during the scheduled injection time interval. Therefore, the input controller must inform the request processor of available times for scheduling the injection of MA. These available times are based on entry times that the input controller has scheduled for other messages. In order for an injection time interval to be available, the input controller must have a free (not previously scheduled) input line into the data switch during the complete scheduled injection time interval. A request processor responds to an input controller scheduling request either by rejecting the request or else, by scheduling a time interval for sending the message through the data switch. The request processor also assigns an output controller bin to receive the segments of the message. The assignment of the output controller bin is equivalent to the assigning of the path from the data switches to the output bin. Therefore, the request processor logic determines a portion of the path for the message to follow through the switching system as well as assigning a storage location (bin) in which to place the message MA. In one embodiment using multiple copies of the data switches, the request processor also assigns a data switch or group of data switches to be used by all of the segments of the message packet, thereby reducing or avoiding the need to further divide the segments of MA into sub-segments. In a first embodiment, if the request processor denies the request to schedule the message MA, the input controller immediately discards MA. In a second embodiment, if the request is denied, the request processor is free to make another request for the same message at a later time. In the second embodiment, if the request is denied a sufficient number of times, or remains unsent for a sufficient length of time, the input controller is forced to discard the message. In case the input controller is forced to discard messages, it will discard those having the lowest priority of service among all of the messages targeted for a given output controller. The input controller is aware of what messages have been discarded and is in a position to send controlling messages to upstream system management devices.

There are a number of alternate schemes for an input controller to select a suitable time for sending a message though the switch. In a first embodiment, the request packet contains a list of times that the input controller has available for sending the message. The request processor either chooses one of these times or returns a negative response to all of the times. In a second embodiment, the input controller only sends requests when all future times following a given future time are available. In the first and second embodiments, the input controller always sends the message at the time scheduled by the request processor. In a third embodiment, the input controller does not send a list of acceptable times and if the request processor schedules a time that the input controller cannot use, then the input controller sends a second request asking for a new time. In one embodiment, the segments of MA are sent one after the other in sequential order with no time gaps between the message segments. In an alternate embodiment disclosed later in this patent, time gaps between the segments are allowed. Since, in the embodiment disclosed here, these gaps are not allowed, the message insertion starting time and the number of message segments completely define the message insertion time interval. An input controller submits a request containing acceptable message sending starting times and the number of segments in the message. The request also states the priority of the message. In many Internet applications the priority is at least partially based on quality of service. In some communication applications, the priority is based on the time that the message has been in the system. In some applications, the priority is based on the amount of data in the input buffer, with higher priority being given to messages in buffers that have limited available memory. In some computing applications, the priority is based on other considerations. One method for assigning priority is as follows. Certain messages are assigned a highest quality of service level and are guaranteed to be sent through the switch as quickly as possible, without ever being discarded. These messages are granted the highest priority. For all other messages, there are three scores S₁, S₂, and S₃, with S₁ being based on the QOS of the message, S₂ being based on the length of time that the message packet has been in the system, and S₃ being based on the amount of available space in the input buffer. The priority of the message packet is then set to S₁+S₂+S₃.

The request processor associated with the message's target output either rejects the request or schedules a time for the input controller to begin inserting packets into the switch. The request processor also reserves an output controller bin to which all of the message packets will be sent. The input controller then adds bin address information to the message header and sends the segments consecutively through the data switch to the assigned bin.

There are a number of algorithms that can be used to govern the flow of data from the output controllers to the I/O devices. One simple and effective algorithm described here obeys the following set of defining rules: 1) An output controller sends only complete packets to the I/O device; 2) An output controller sends higher priority messages ahead of lower priority messages; 3) In case there are two packets P and Q with the same priority at an output controller and there are no packets of higher priority than P and Q at the output controller, then either P or Q is sent first according to which one has been at the output controller longer; 4) In case P and Q have arrived at the same time, then the choice of which of P or Q to send first is random or is based on the location of the bins holding P and Q; 5) For each priority level PL, there is a number FPL so that if the target output controller has more than FPL remaining buffer space, then the request processor will only attempt to schedule messages with priority level PL and above to be sent through the data switch to the output controller. Since the request processor governs the flow of all of the segments sent to an output controller that it represents and since the request processor knows the algorithm that the output controller is using, the request processor has all of the information that it needs to control the flow of data to the set of output controllers under its control.

In cases where the maximum data flow into an output controller does not exceed the maximum flow out of the output controller's associated device, then all messages sent through the switch are sent downstream. In case the maximum data flow rate into an output controller exceeds the maximum flow out of the output controller, algorithms that discard low priority data from the output controller can be employed with advantage. Similar algorithms can be employed to discard data that has passed through the switch and is stored in line cards.

The Request, Answer, and Data Switches

In one embodiment described herein, the congestion-free switching system with intelligent control contains a request switch RS, either a single answer switch AS or two answer switches AS1 and AS2, a first data switch DS1 and a second data switch DS2. The additional data switch and the additional answer switch (if present) are used to place the packets in the proper bins.

A main theme of the present invention is that some system I/O devices carry information at higher data rates than others. The inputs and outputs of the system switches are properly balanced to account for the unequal data rates of the I/O devices. On the input side this is achieved by assigning to each input controller a number of DS1, RS, and AS1 switch input ports that is proportional to the input port data rate. So, as an illustrative example, if two input controllers ICW and ICX are each capable of receiving data at a rate of R bits per second, a third input controller ICY is capable of receiving data at a rate 2-R bits per second and a fourth input controller ICZ is capable of receiving data at a rate of 20R bits per second and ICY injects its data into exactly one assigned DS1 input port, then ICW and ICX share an input port and ICZ is assigned 10 input ports.

A similar load balancing is applied to the outputs of the switches. The output port load balancing is a main topic of the present patent and will be discussed in detail later in this document.

The request switch RS carries request packets from the input controllers to the request processors. It is convenient for RS to be a self-routing switch with each output capable of simultaneously receiving data from a plurality of inputs. A switch of the type described in patent No. 2 is ideal for this purpose. In an embodiment described in this patent, RS is such a switch. In this embodiment, the number of request processors is not necessarily equal to the number of rings (rows) on the bottom level (L0) of RS. It may be the case that some request processors represent a single I/O device while other request processors represent multiple I/O devices. In other embodiments, it may be convenient to have multiple Level 0 rings of RS capable of sending data into a single request processor. There are a number of schemes that fairly and effectively deliver data to a request processor that is capable of receiving data from a number of Level 0 rings of the request switch RS. Consider two embodiments of a system which has a request processor that receives data from NR Level 0 request switch rings. In a first embodiment of this system, a set of input controllers that collectively carry 1/NR of the input data send their request packets through a single level 0 request switch ring. In a second embodiment, input controllers send their requests to the NR Level 0 rings of the request switch at random.

The request processors send answer packets back to the input controllers. In an embodiment presented in the present patent, AS1 can be a switch of the type described in patent No. 2. This switch is optimized to handle the maximum data load of answer packets from the request processors to the input controllers. Since the flow of data into AS1 is controlled by the request processors, it is possible for AS1 to be a stair step switch of the type taught in patent No. 3. However, since the answer packets are so short, a switch of the type described in patent No. 2 is also acceptable.

The input controller has buffers that receive answer packets from the answer switches. In a first embodiment, these buffers are divided into bins. AS2 is composed of small switches (possibly crossbars) that carry packets from AS1 to the bin associated with the request packet RQP. The request processor is able to send the answer to the proper bin because the bin number is included in the request packet. A crossbar switch works well here because the request processor never sends two answer packets to the same bin in the same request cycle. In a second embodiment, the switch AS2 is eliminated and the answer packets are handled in a method similar to the way that they are handled in patent No. 8.

At the time assigned by the request processor, the data packets are sent through the data switch DS1 to a row R on level L0 of DS1, where R is positioned to deliver the data packet to its target output controller. In case R is the only ring that is capable of sending data to the target output controller, the address of R is completely given by the input controller. In case multiple rings are capable of delivering data to the target output controller, a portion of the address of R is given by the input controller and the remainder of the address is given by the request processor. The portion of the address furnished by the input controller is sufficient for the input controller to determine the set of rings that feed the given output controller. The request processor furnishes the rest of the address. Because the request processors control the flow into DS1 at all times, it is possible for DS1 to be a stair step switch of the type described in patent No. 3. Since, in some embodiments, the bandwidth of DS1 is significantly greater than the bandwidth of RS, it is sometimes desirable for DS1 to have more levels than RS. These additional levels allow a single input controller to insert multiple segments simultaneously and also allow a single output controller to receive a sufficiently large number of messages simultaneously.

The data switch DS2 can be constructed using a number of small switches (possibly crossbar switches). Crossbar switches work well here because the request processors guarantee that no two messages are sent simultaneously to the same bin.

In one embodiment of the present invention, the very high data rate devices are capable of inserting data into multiple input ports of the request, answer and data switches and there are a plurality of rows on the lowest level of DS1 that are capable of sending data to a single output controller associated with a very high data rate I/O device. Moreover, multiple rings on the lowest level of RS are capable of sending data to a single request processor.

Data packets targeted for a very high data rate output device are stored in output bins. The input controllers segment each data packet and send all of the segments of a given packet in sequential order to a single bin, where they are stored as a single reassembled message. For very high data rate output controllers that receive data from more than one output ring, the output ring (or output row of a stair-step switch) and bin number are assigned to a data packet by a request processor.

Moderately high data rate devices are able to insert data into a fewer number of request switch input ports, answer switch input ports and data switch input ports. An output controller associated with a moderately high data rate output port receives all of its data from a single lowest level row of DS1 (as indicated in FIG. 2B). Data segments corresponding to a data packet P targeted to such an I/O device are sent in sequential order to the same bin. This bin is assigned to all the segments of P by the request processor. In this case the request processor is free to choose from all of the bins of the output controller, but is not free to choose the DS1 output row because only one output row is capable of sending data to the targeted I/O device.

Low data rate I/O devices are assigned fewer request switch, answer switch, and data switch input ports. In one embodiment, a plurality of low data rate I/O devices share a single switch input port. A single output row of DS1 is also capable of sending data to several low data rate I/O devices. A request processor scheduling data to such an output device must choose a bin that delivers data to the proper output device.

System Operation

In a first embodiment of the present invention, there is a pair of data switches DS1 and DS2 such that all data flowing through the system first flows through DS1 and then flows through DS2. A second embodiment of the present invention designed for greater throughput employs multiple copies of the switch pairs DS1 and DS2. The first embodiment is disclosed in the following paragraph.

The system operation can be described by tracking the progress of a single data packet DP*. The packet DP* arrives at I/O device IOD_{IN} and is targeted for I/O device IOD_{OUT}. DP* will travel from input controller IC_{IN} to output controller OC_{OUT}. RP_{OUT} is the request processor that governs the flow of data into IOD_{OUT}. Responsive to the arrival of DP*, IC_{IN} constructs a request packet RPAC* corresponding to DP*. The header of RPAC* contains the address of RP_{OUT}. The payload of RPAC* contains information including: 1) the number of segments in DP*; 2) information for addressing the target I/O device IOD_{OUT}; 3) the priority of DP* (said priority usually based at least in part on the QOS value of DP*); 4) a list of times that the input controller can inject the message into the system. The packet RPAC* is sent through the request switch RS to RP_{OUT}. Since RP_{OUT} schedules all data into OC_{OUT} and RP_{OUT} is capable of calculating the flow of data out of OC_{OUT}, RP_{OUT} keeps track of the amount of available space in all of the OC_{OUT} bins as well as the present and future availability of data lines into the bins. In one embodiment, certain bins are reserved for storing packets with priority levels within a specific range. One feature of the algorithm used by RP_{OUT} is to schedule packets at times in the future with there being a maximum time in the future for scheduling packets. The request processor responds to the request packet RPAC* by returning an answer packet APAC* to IC_{IN} with APAC* containing either a denial or an acceptance of the request. In case the request is denied, IC_{IN} can make another request for DP* in the future or IC_{IN} can discard DP*. In one simple strategy, IC_{IN} can discard all packets that are not scheduled on the first request. In case the request is accepted, the request processor prepares an answer packet APAC* whose header indicates the address of IC_{IN}. The answer packet APAC* contains information including the segment insertion time N* to begin sending the segments of DP* and the location to send the segments. The location is denoted by a row ROW of level L0 of DS1 and a bin number BIN that is accessible from ROW. The data packet DP* is segmented into NS* segments, which are sent by the input controller IC_{IN} at segment sending times N*, N*+1, . . . , N*+NS*−1. Each of the segments contain ROW and BIN in the header. The segments of DP* typically do not take the same path through DS1 and consequently may emerge from different outputs of ROW. The segments pass through DS2 and all arrive at BIN. The scheduling of the entire message by the request processor insures that the message segments arrive at the same bin in sequential order, so that reassembly of the segments of DP* has occurred at that point. The output controller uses the aforementioned algorithm to send DP* to IOD_{OUT}. The packets are now conveniently positioned for sending from IOD_{OUT} to a downstream device.

Multiple Data Switch Embodiments

Patent eight taught a method of using multiple data switches to increase throughput. In that invention, using a stack of Q data switches, each message packet segment S is decomposed into Q sub-segments with each pair of sub-segments passing through different data switches in the stack. In the present invention, the multiple data switch embodiment of patent eight will be referred to as the total sub-segment parallel embodiment. The techniques employed in the total sub-segment embodiment are extremely effective for a class of systems. However, in the total sub-segment embodiment, each sub-segment contains a copy of the segment header, therefore, as the number of data switches increases, the ratio of header to payload increases. This problem is advantageously avoided in the embodiment taught in the following section that describes a multiple data switch without sub-segmentation embodiment. In the detailed description of the present invention, a third hybrid parallel data switch embodiment is taught.

Multiple Data Switches Without Sub-Segmentation

In the technique described in this section, multiple data switches are employed, but the header to payload ratio remains constant. As a result, the present invention can be used to build systems with port speeds well in excess of 10 Gbit/sec. Entire message packets are fed into the system by the I/O devices. Segmentation and reassembly occur in the switching system, and entire message packets exit the system. This is accomplished by an expanded role of the request processors.

As illustrated in FIG. 7B and FIG. 7C, each input controller is capable of sending messages to a number of switch pair systems (DS1 and DS2). As in the single switch pair system, when a message packet DP* enters an I/O device an input controller sends a request packet to the request processor. The request processor may accept or deny the request. In case the request processor accepts the request, the request processor selects the output bin for DP* by specifying the following three items: 1) which of the data switch pairs will carry the message; 2) which output ring will be targeted; and 3) which bin fed by that output ring will accept the message. The request processor is able to assign a data switch because it has in its local memory a record of all messages already scheduled to enter the data switches. In extremely large systems employing a very large number of data switch pairs, the data can be switched into the proper data switch pair by another stair step switch of the type described in patent No. 3.

Yet another embodiment employing multiple data switch copies uses a technique employing partial sub-segmentation. For example, in a system utilizing a stack of 16 switches, each message segment can be divided into 4 sub-segments with the request processor assigning a bank of four switches to each message. This hybrid embodiment will be described later in this patent.

Output Buffers

In one embodiment, there are multiple levels of output buffers, each with bins for holding packets. In the system discussed here, there are two levels of output buffers. Data packets move from the switch DS2 to the output controllers. Each output controller contains an output controller buffer OCB. The output controller moves data from an output controller buffer to an output device buffer ODB. In some applications, the output device is a line card. Finally, data exits the System with Intelligent Control through an output device output port. In some applications, the maximum available bandwidth B1 into OCB exceeds the maximum available bandwidth B2 from OCB to ODB. This bandwidth B2 exceeds the maximum available exit bandwidth B3 from ODB. In some applications the capacity of ODB exceeds the capacity of OCB.

Multicasting

In one embodiment, there is a provision for sending a single data packet to multiple output devices. This is accomplished by decomposing the set of output devices into groups. Each output device group G contains a representative member ODG. A message packet P that is to be multicast to the output devices in the group G is sent to ODG. The output device ODG is informed that the packet P is to be multicast either because there is a header bit in P indicating that it is a multicast packet or because the packet P is delivered into a special multicast bin in ODG. The packet P is then sent from ODG to all of the members of G. If no two device groups contain a common member, then a crossbar switch can adequately perform the multicast switching. The algorithm controlling the request processor limits the number of messages in the output controller buffer. In one embodiment, the output controller guarantees that it never sends two multicast messages into the multicast switch simultaneously. Since an input controller can inject multiple messages into the switch at a given time, the switch is well suited to multicasting to an arbitrary group as well as multicasting to a predetermined group G.

Discarding Data

In one embodiment of the Congestion Free Switching System with Intelligent control, all data that is approved by the request processors is guaranteed to exit the system. In these systems, all of the discarded data can be discarded by the input controllers. In other embodiments, data packets can be discarded by the output controllers, by the output devices or by both as well as by the input controllers. In case the output controllers have an algorithm to discard packets, this algorithm is also known by the request processors. Thus, the request processors have the ability to track the status of the output controller buffers without said request processor receiving information from the output controller.

### BRIEF DESCRIPTION OF THE DRAWINGS

FIG. 1A is a schematic block diagram of a switching system similar in construction and function to those described in patent No. 8. It does show, however, that the number of I/O devices, input controllers and output controllers (which is J in the illustration) may differ from the number of request processors (which is N in the illustration). The diagram also shows the addition of a second answer switch and a second data switch. These modifications advantageously allow for innovative new functionality.

FIG. 1B is a schematic block diagram showing additional detail of the data switches DS1 and DS2. It shows that DS2 is composed of several small switches (such as crossbars), which further process segment packets as they leave DS1 on the way to the output controllers.

FIG. 2A shows a plurality of output nodes on a Level 0 ring of DS1 sending data into a DS2 switch. Delay FIFOs of varying lengths are used at the switch inputs so that, advantageously, in each packet sending cycle all first bits of the packets arrive simultaneously at the switch.

FIG. 2B shows a single Level 0 ring (row) of DS1 sending its output into a single DS2 switch, which then sends the processed data into a single output controller. This type of construction could be used advantageously to control data on a medium speed line.

FIG. 2C shows a single Level 0 ring of DS1 sending its output into a single DS2 switch. Output from the DS2 switch is used to feed a plurality of output controllers. This type of construction could be used advantageously to control data on a plurality of low-speed lines.

FIG. 2D shows a plurality (two) Level 0 rings of DS1 each sending its output into a DS2 switch. Each DS2 switch then feed data into a single output controller. This type of construction could be used advantageously to control data on a high-speed I/O device.

FIG. 3A is a schematic block diagram of a request switch whose design is of the type taught in patent No. 2 with a slight change of including and additional Level 0.

FIG. 3B is a schematic block diagram of a node array NA as used in FIGS. 3A, 3C, and 3E.

FIG. 3C is a schematic block diagram of an answer switch whose design is of the type taught in patent No. 2 except for an addition of an additional level.

FIG. 3D is a schematic block diagram showing details of the answer switch system.

FIG. 3E is a schematic block diagram of a data switch with N+K+1 levels whose design is a stair-step switch of the type taught in patent No. 3.

FIG. 4A through FIG. 4D are diagrams showing the formats of several packets used in the switching system described by this invention.

FIG. 5 is a schematic block diagram showing a plurality of data lines between two nodes forming a wide data path. This structure may be used in high data rate embodiments.

FIG. 6A through FIG. 6D illustrate modifications to the switching system 100 for supporting a multicasting function. FIG. 6A shows the addition of a multicast unit MCU to the system 100. FIG. 6B shows details of the multicast unit, which contains data buses and a multicast switch MCS.

FIG. 6C is a block diagram of an input/output device 10D as modified for multicasting, while FIG. 6D depicts similar modifications made to an output controller OC.

FIG. 7A illustrates the use of multiple switching systems 100 in an alternate embodiment of this invention.

FIG. 7B illustrates another embodiment including multiple copies of the data switch.

FIG. 7C illustrates another embodiment including multiple copies of the data switch and corresponding multiple copies of a portion of the input controller and multiple copies of a portion of the output controller so that certain input controller and output controller functions are on each of the data switches.

FIG. 7D, FIG. 7E and FIG. 7F illustrate an embodiment of the switching system supporting hardware flexibility.

FIG. 8 Illustrates an alternative message segment sequencing scheme.

### DETAILED DESCRIPTION

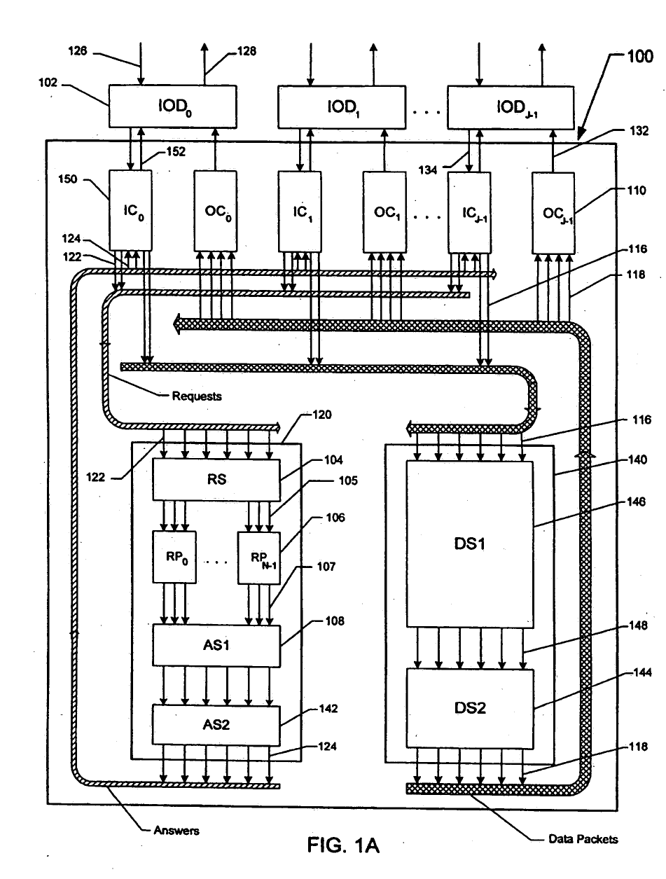

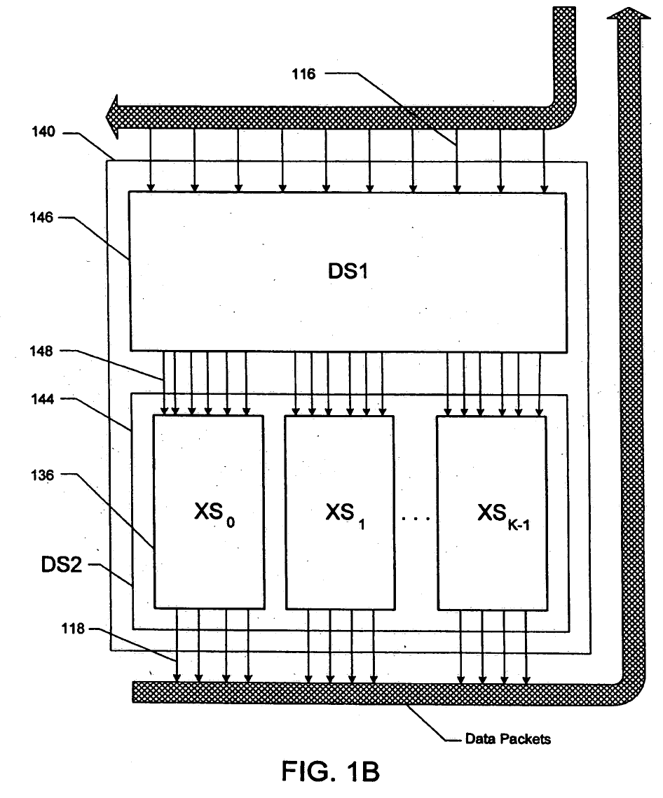

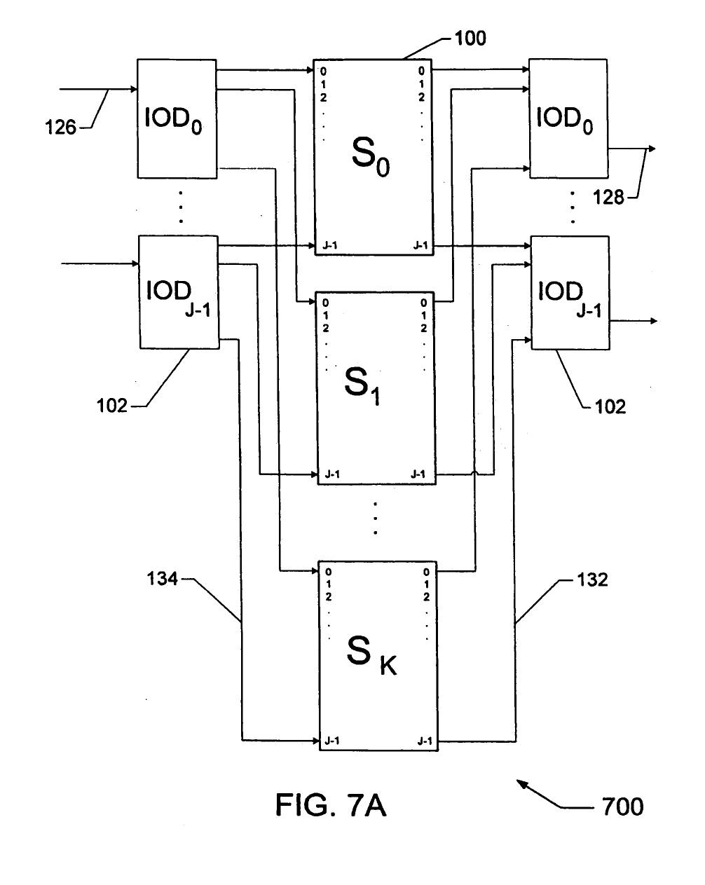

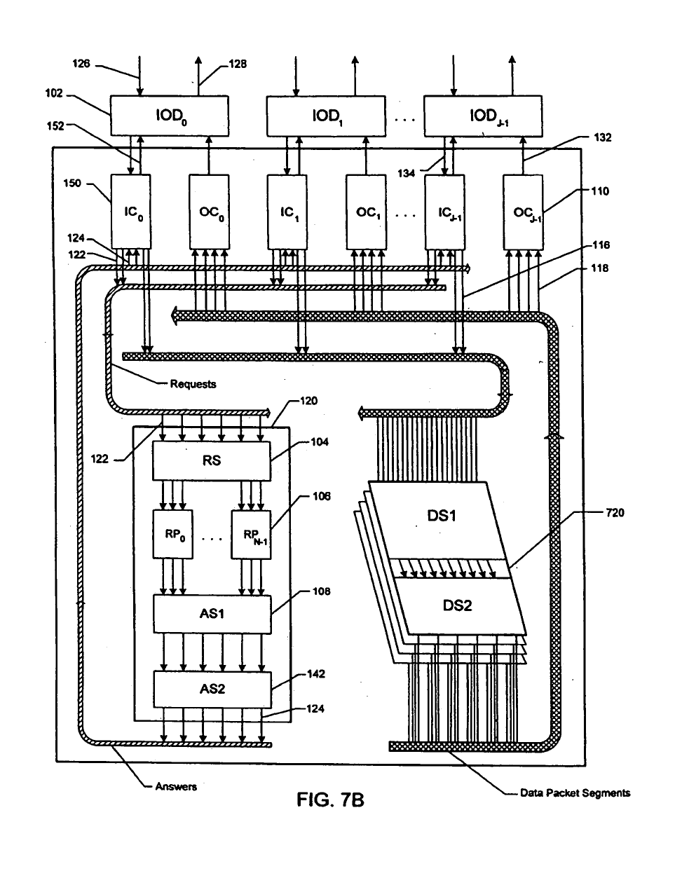

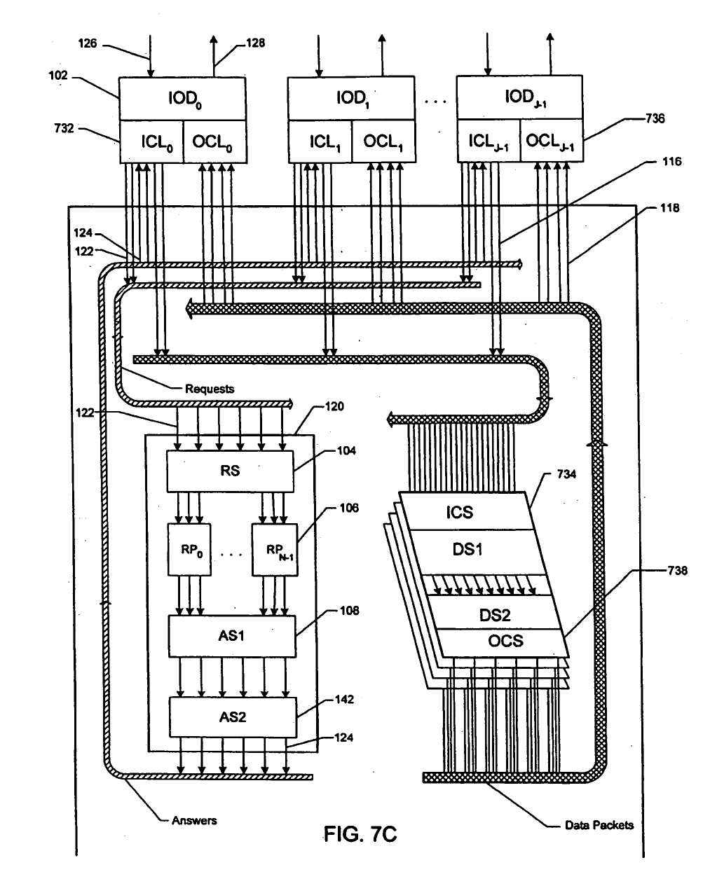

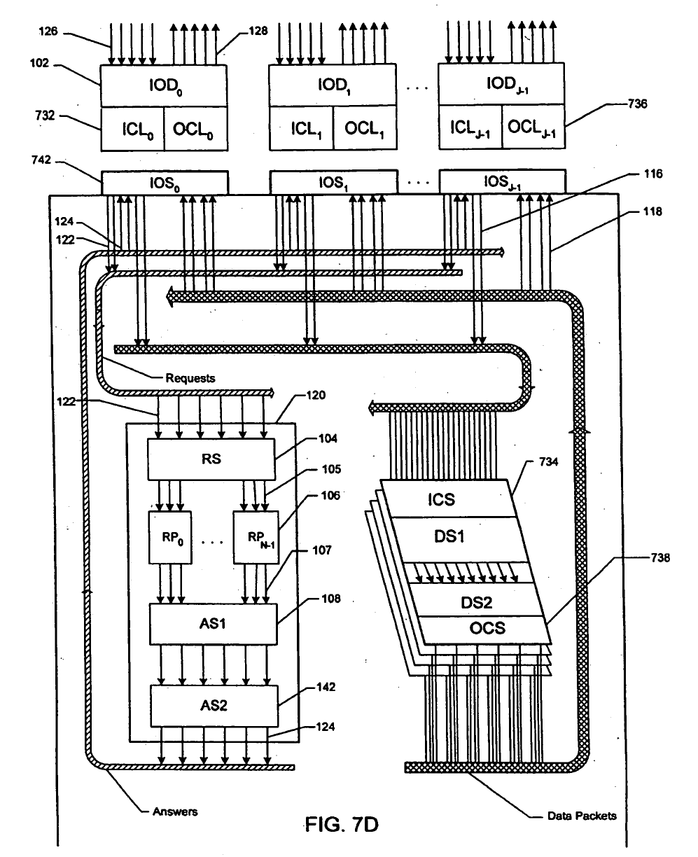

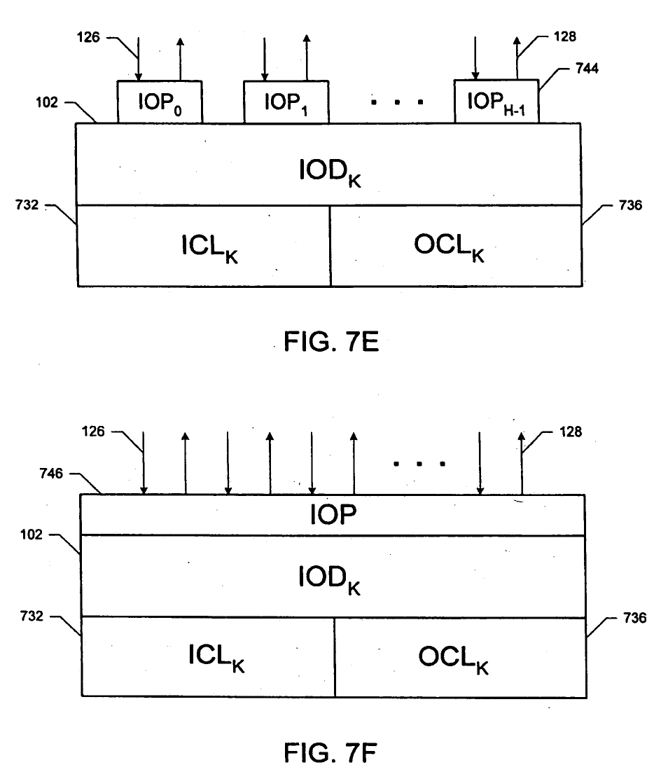

FIG. 1A depicts a congestion-free switching system 100 similar to that previously taught in patent No. 8. Some differences between the two are apparent from the illustration. Note that while the system in FIG. 1A contains J input controllers IC 150 and J output controllers OC 110, the number of request processors RP 106 is N, which is an integer that may be different from J. Another feature to note is that there are two answer switches, AS1 108 and AS2 142, and two data switches, DS1 146 and DS2 144, rather than a single answer switch and a single data switch as used in patent No. 8. In one embodiment of patent No. 8, an input controller sends a request packet to a request processor asking permission to send an entire message packet to the data switch. In the present invention, this idea is expanded upon in a number of ways in order to address the issue of request processor complexity, to increase the likelihood that full packet requests will receive approval, and to manage the data switch output of the full packets. In a system where the average message consists of 20 segments, this sending a request to schedule an entire message has an advantage of decreasing the bandwidth through the request switch by 95%. Another distinction between the present invention and invention of patent No. 8 is that, in an embodiment where multiple Level 0 DS1 rings carry data to a single I/O device, the request processor determines which Level 0 ring of DS1 will receive all of the segments of a given message. Another distinction between the present invention and invention of patent No. 8 is that in addition to scheduling a time interval for the injection of a message into the data switch, the request processors also determine a bin 212 in which to place all of the segments of a given packet. A consequence of the additional request processor functions of assigning both a Level 0 ring and a particular bin to the segments of a packet is that packet segments are reassembled in the output controller, advantageously relieving the line cards of this responsibility. In one embodiment of the present invention that utilizes multiple data switches as illustrated in FIG. 7C, the request processors determine which data switch or set of data switches receives a given message. This request processor function (not disclosed in patent No. 8) advantageously eliminates the partitioning of segments into sub-segments; thereby avoiding the need to send multiple copies of a given segment header through the data switches. Notice that the assigning of a Level 0 ring to a message is equivalent to the assigning an output transmission line 148 from DS1. The assigning of a bin to a message is equivalent to assigning an output transmission line 118 from DS2. In the embodiment illustrated in FIG. 7C, where DS1 is built using a plurality of switches, the assigning of one of the switches to transmit a message is equivalent to the assigning of a data path into DS1 to a message packet scheduled to enter DS1.

The system illustrated in FIG. 7C is capable of operating in a mode that allows the user to set up a virtual circuit switch of a certain bandwidth. The message packets that are handled in a special way to emulate a circuit connection contain a special marking bit in their header. Messages with this header can access a special memory to find their output port. It is convenient to equip those memories with leaky bucket counters to make sure that the bandwidth reserved for these messages is not exceeded. Special lines through the data section of the switch can be reserved for these messages and special output bins can be reserved to receive these messages. In this mode of operation, the routers of FIG. 7C can be viewed as a combination packet switch and circuit switches.

The function of DS2 is to place the segments of a given message sequentially into a single, predetermined bin. These modifications to the basic switching system previously taught advantageously allow switching system 100 to manage efficiently the data I/O devices, 10D 102, where some of the attached lines, 126 and 128, have higher data rates than others. This new structure also allows message segment packets to be reassembled into complete message packets by the DS2 switches, thus relieving the I/O devices 102 of this duty. The flow of data through this innovative new switching system 100 will be discussed next. Functions that are identical to those in patent No. 8 will be indicated but not discussed in detail.

Data packets enter and exit the switching system from a set of J I/O devices, IOD₀, IOD₁, . . . IOD_{J-1}, via lines 134 and 132 respectively. These packets are received by a corresponding set of J input controllers, IC₀, IC₁, . . . IC_{J-1}. Each input controller 150 processes its incoming message packets by dividing them into segments that can be conveniently managed by the data switches. These segment packets are stored by each input controller in its Input Packet Buffer, with summary information on each message packet stored in its Keys Buffer. For each message packet, a request packet 400 is built and stored in a Request Buffer. The request packet differs from that described in patent No. 8 in that it contains both the request processor ring RPR 404 and the output controller number OCN 406. These additional fields are needed because a single request processor in this embodiment may process data for more than one output controller. Each input controller will have a table containing the number (address) of the request processor used for each output controller.

In a first embodiment, data packets arriving at the I/O devices are immediately sent to the input controllers. In a second embodiment, the data packet is stored in the I/O device and the information needed to build a request packet is sent to the input controllers. The input controllers can use lines 152 to request that the data be sent when it is needed for transmission through the switch.

As in patent No. 8, there are request cycles during which each input controller ready to do so sends one or more request packets 400 to the request switch RS 104. The request switch, which is an MLML (Multiple Level Minimum Logic) switch having N+1 levels, delivers each request packet to the appropriate request processor 106 using the RPR field 404 as an address. If the request processor manages more than one output controller, the OCN field 406 designates the output controller for the current request. Each request processor examines the requests for its set of output controllers and generates replies in the form of Answer Packets 410, which are returned to the requesting input controllers via the Answer Switches AS1 and AS2, details of which will be discussed below. In this embodiment, each answer packet 410 that approves a request will inform the input controller to send all segments of the requested message packet sequentially to data switch DS1, beginning at a specified segment sending time ST 420. Thus, if the message packet contains NS 416 segments, the corresponding segment packets 420 will be sent in order at times ST, ST+1, ST+2, . . . , ST+NS−1. The data switch processor 140 is composed of two switches, DS1 and DS2, which receive the segment packets and directs each one to the appropriate output controller. The reassembled message packets are sent by the output controllers to the corresponding I/O devices 102.

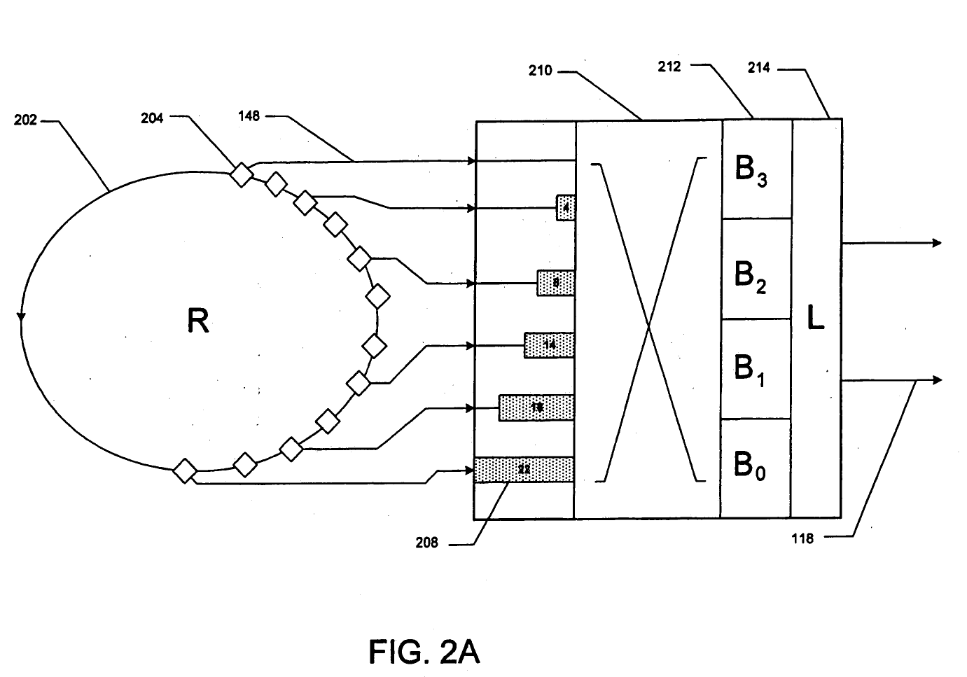

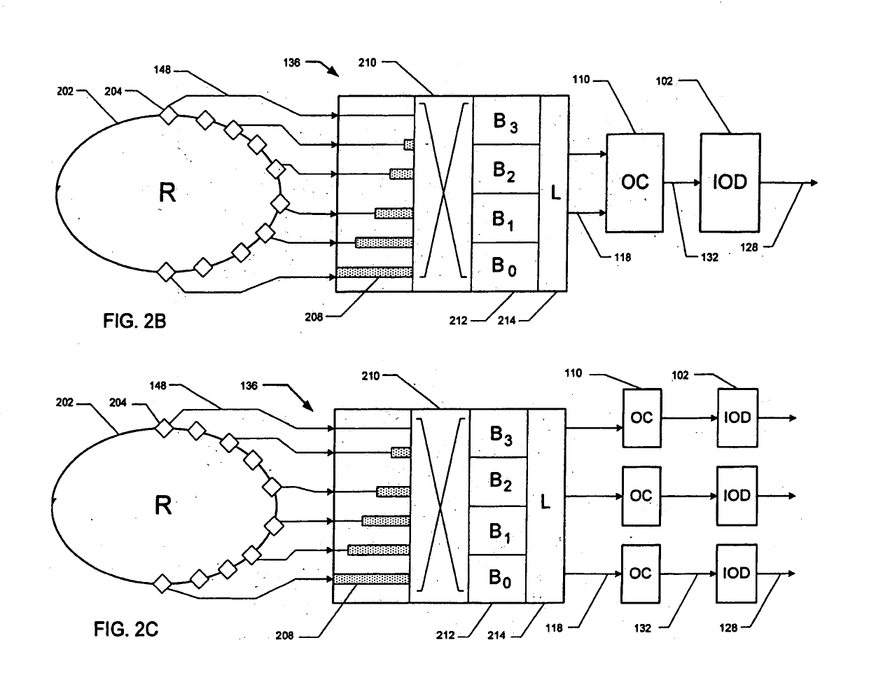

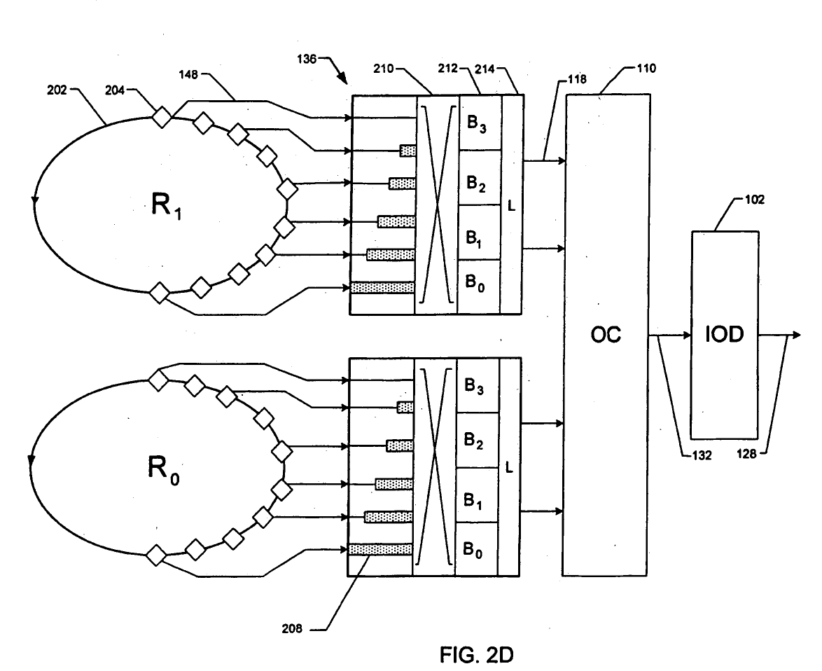

FIG. 1B shows additional details of the data switch 140. While DS1 is an MLML switch, the DS2 switch is composed of a plurality of small switches XSⱼ 136, one for each ring at the bottom level (Level 0) of DS1. Thus, for example, if DS1 is a six level MLML switch with 32 rings at level 0, then DS2 will consist of 32 switches XS₀, XS₁, . . . , XS₃₁. This design of 10 the DS2 switch is also used for AS2 142 answer switches in embodiments containing them. FIG. 2A illustrates the basic functions of an XS switch module. The switch is illustrated as a 6×4 switch with six input lines 148 from the plurality of nodes 204 on the ring R 202. Of the six input lines, no more than four will be “hot” (i.e. carry data) during a given sending cycle. XS may be a simple crossbar switch since each request processor assures that no two packets destined for the same bin will arrive at a ring during a given cycle. Delay FIFOs 208 are used to synchronize the entrance of segments into the switch. Since it requires two clock ticks for the header bit of a segment to travel from one node to the next node on the same level and the two extreme nodes in the figure are 11 nodes apart, a delay FIFO of 22 ticks is used. Other FIFO values given reflect the distance of the node from the last node on R having an input line into the switch. In this illustrative example, DS1 and DS2 are of a fixed size and the location of the output ports of the Level 0 ring are given. This size and location data is for illustrative purposes only and the concepts disclosed for this size apply to systems of other sizes.

In the present embodiment of the system, the input controllers send all segments of a message packet in sequential order during consecutive sending cycles with each one addressed to the same ring and bin. While several segments (up to four in this example) may arrive at ring R during a given cycle, each one will be from a different message and no two will be destined for the same bin. Logic L 214 in the module sets the switch 210 so that each arriving segment is sent to its respective bin. In order to set the switch 201, the logic module L reads the header information of the incoming packets. Lines carrying the header information to the logic module L are not illustrated in FIG. 2A. During this process, all remaining header information is stripped from the segment so that only the payload field and end of message field remain. The end of message indicator on the last segment of a message allows for the separation of complete message packets within a bin. Since the segments for a given packet are sent sequentially to the same bin arrive in the order sent, message packets are advantageously reassembled automatically during this process. Logic 214 within the switch module directs the reassembled message packets from the bins to a set of one or more output controllers via lines 118.

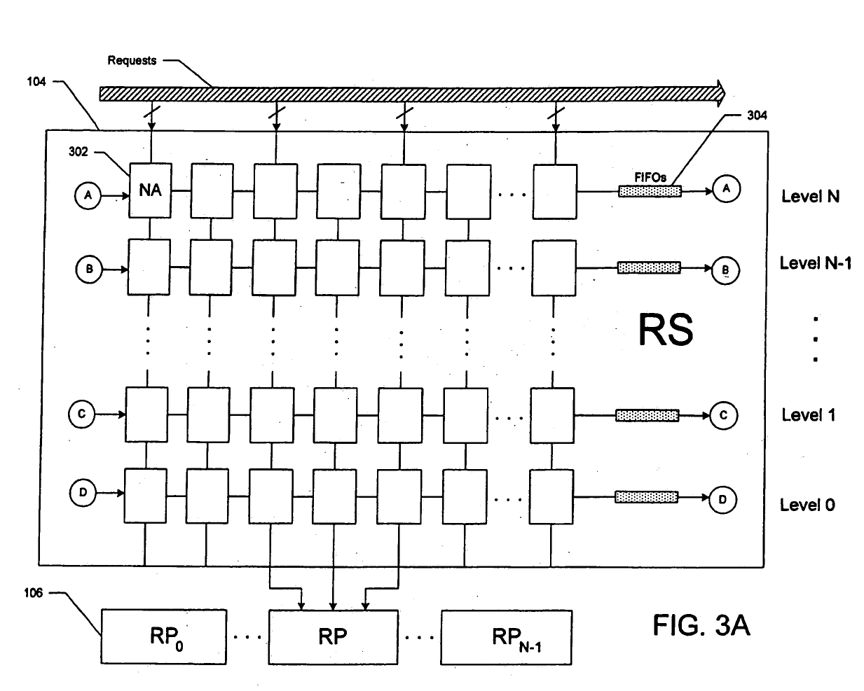

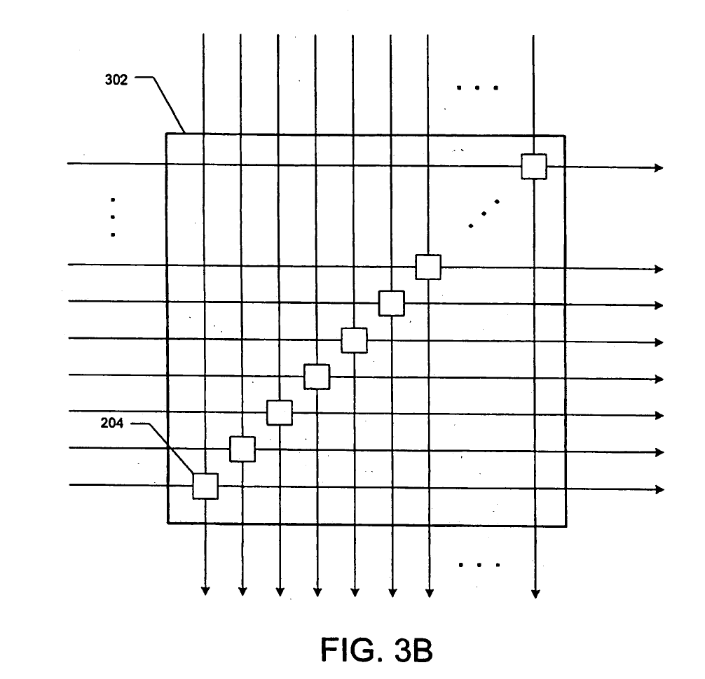

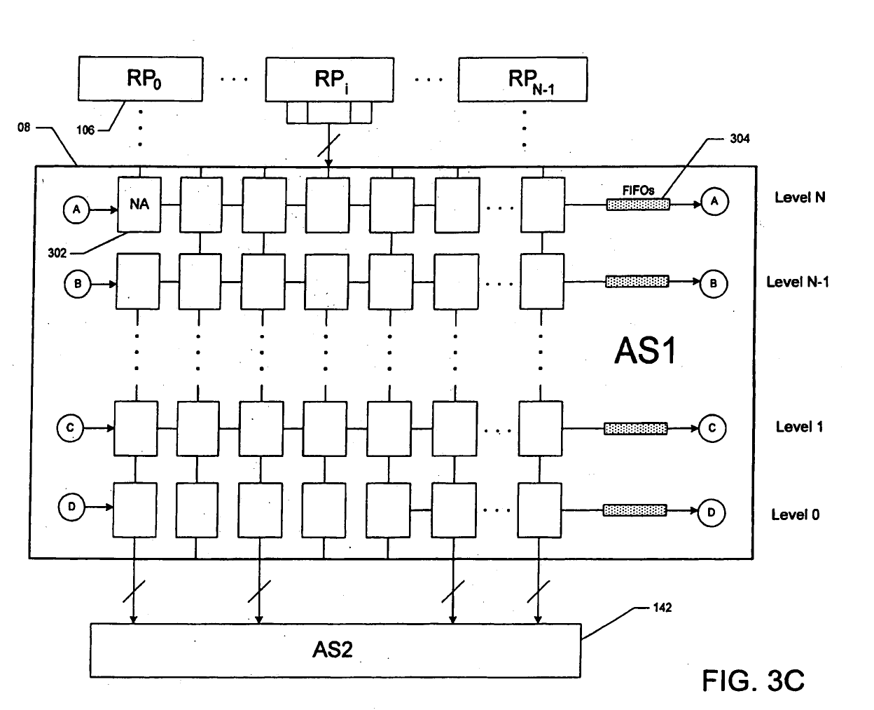

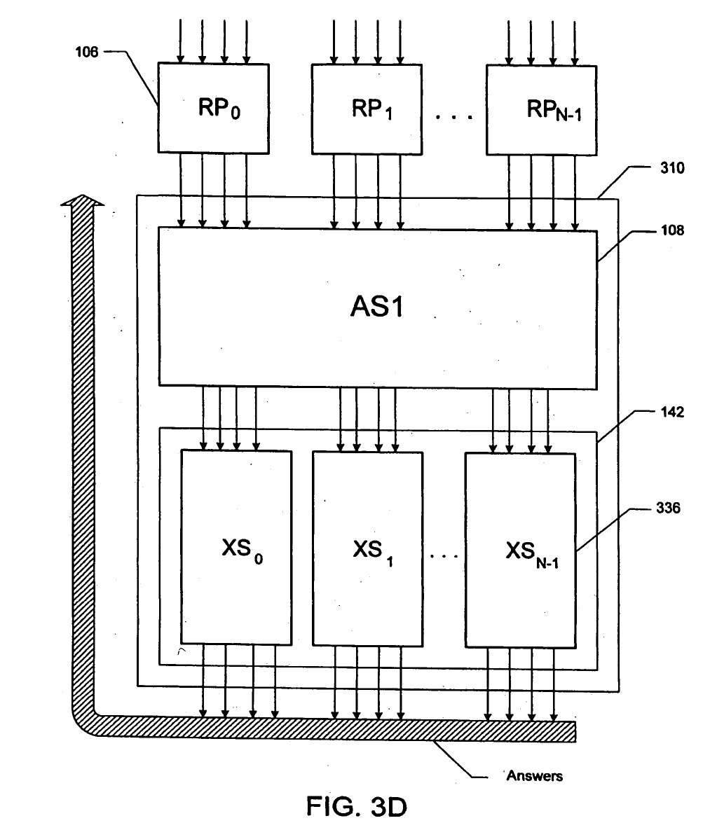

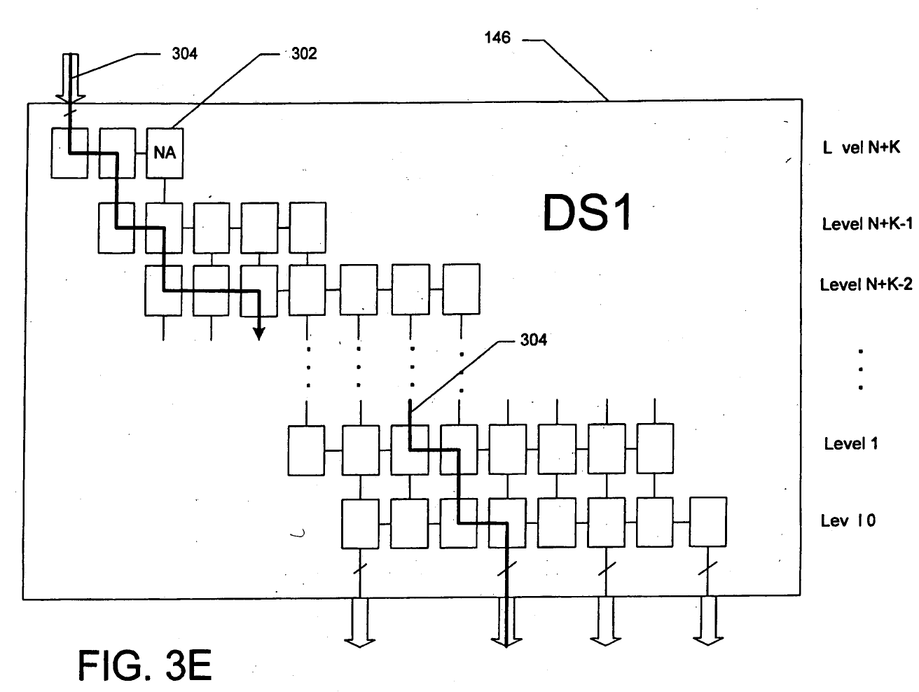

FIG. 2A shows the bottom ring of a MLML network. In fact, since the data entering the data switch is controlled by the request processors, DS1 can be a stair-step type switch illustrated in FIG. 3E. The design parameters of the stair-step are set using simulations of data flow through the switch. In case a stair step interconnect is used for DS1, the ring R of FIGS. 2A through 2D is replaced by a shift register as illustrated by the bottom row of FIG. 3E. In fact, as is pointed out in patent two, it is not necessary for a “double down” or flat latency switch to have level zero nodes. The elimination of level zero advantageously saves hardware. A level zero is included in the figures of the present invention in order to aid in the discussion, but in the actual fabrication of the systems it can be eliminated.

FIGS. 2B, 2C and 2D illustrate some possible alternative configurations of the XS switches. Multiple configurations can be used in the same system. In FIG. 2B a single ring R sends data through an XS switch module 136 to a single output controller 110. This setup may be used to service output to a medium speed line in a switching system. For low-speed lines a configuration like the one depicted in FIG. 2C may be useful. In it a single ring R sends data through an XS switch to a plurality of output controllers. In FIG. 2D two rings 202 (denoted by R0 and R1) at the bottom level of DS1 feed segment packets into two XS switches 136 of DS2, which in turn send reassembled message packets to a single output controller. This configuration may be used to support high-speed lines in a switching system. Other configurations (not illustrated) using variations in the number of rings, the size of the XS switch, the number of bins, or the number of supported output controllers may be appropriate for other embodiments of this invention. In FIG. 2A through FIG. 2D, various interconnects (including interconnects 118, 132 and 128) may be busses consisting of a plurality of interconnect lines. Some or all of the lines may be optical, in which case the system may employ a variety of technologies including, but not limited to, wave division multiplexing.

FIG. 3A shows a request switch RS 104 of the type taught in patent No. 2. As illustrated, RS contains N+1 levels with a plurality of node arrays NA 302 at each level. Each level also contains a set of FIFO buffers 304 whose size is dependent on the size of the request packets. In one embodiment, Level 0 will consist of 2^{N-1} rings, with each ring sending request packets to a given request processor 106. In other embodiments, the request processor may contain a different number of Level 0 rings. This is because, for request processors representing low data rate output controllers, several of the request processors may be fed by a single ring. For request processors representing high data rate output controllers, multiple rings may send data to a given request processor. In one embodiment where multiple rings send data to one request processor, certain of the said rings may be assigned to input controllers. In other embodiments, input controllers can choose these rings at random. In still other embodiments, the node logic at the bottom levels of the request switch can ignore the low order bits and allow messages to flow into any available ring. One skilled in the art will immediately see still other algorithms for sending request packets to request processors served by multiple Level 0 DS1 rings.

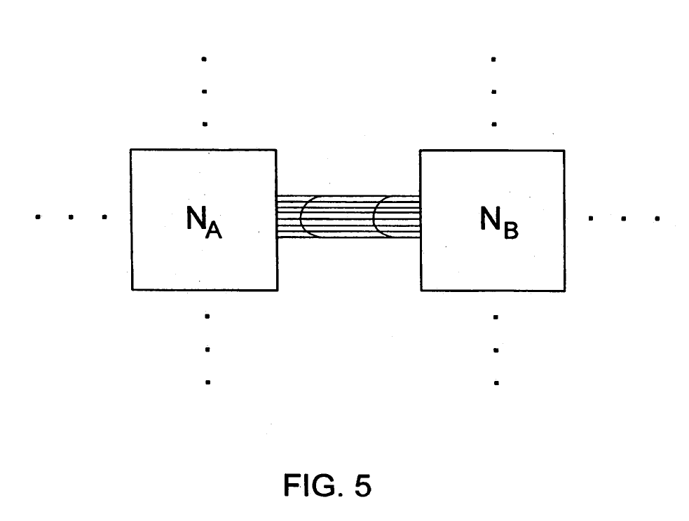

FIG. 3B shows details of a node array 302 as used in FIGS. 3A, 3C and 3E. The node array consists of a plurality of nodes 204 arranged onto a number of rings, which depends on the level of the array in the switch. Packets enter a node from above or from the left (north or west) and either exit to a node at a lower level (south) in the switch or proceed on the same level to a node on the same ring that is to its right (east). The node array illustrated in FIG. 3B is for the simple “single down” switch. Node arrays with richer interconnects are illustrated in the incorporated patents, including the invention of patent No. 2. The connections between nodes may be single lines as illustrated in FIG. 3B or they may consist of busses as illustrated in FIG. 5 or they may be optical interconnects carrying one or more wavelengths of data.

FIG. 3C shows an answer switch AS1 108, which is also of the type taught in patent No. 2. It is similar in construction to the request switch. The size of the FIFOs is dependent on the size of the answer packets. Each request processor 106 sends its answer packets into AS1 with address information sufficient to return the answer to the input controller that sent the request. In embodiments using two answer switches, AS1 and AS2, this information consists of a ring number for AS1 and a bin number for AS2. The ring number is used by AS1 to send an answer packet to a bottom level ring of the switch, which is associated with a set of input controller. Each ring at this level is connected to a small XS switch 336 as illustrated in FIG. 3D, which are identical in function to the XS switches in DS2. These small switches direct the answer packet to the appropriate bin, and each bin is connected by the answer bus to a unique input controller, i.e. the input controller destined to receive the answer packet. In some embodiments, a plurality of bins may be connected to the same input controller. In another embodiment, there is no DS2 switch and the answer packets are handled in the manner disclosed in patent No. 8.

FIG. 3E is schematic diagram of a data switch DS1 146 whose design is a stair-step switch as taught in patent No. 3. As illustrated, DS1 contains N+K levels. In many embodiments, it is advantageous for the data switch to contain more levels than the request switch in order to compensate for the higher bandwidth through the data switch. The extra levels allow an input controller to insert multiple messages into the data switch simultaneously. Being a stair-step switch, DS1 will be over engineered using Monte Carlo simulations so that no packets ever reach the end of a row before traveling to a lower level or on to the DS2 switch.

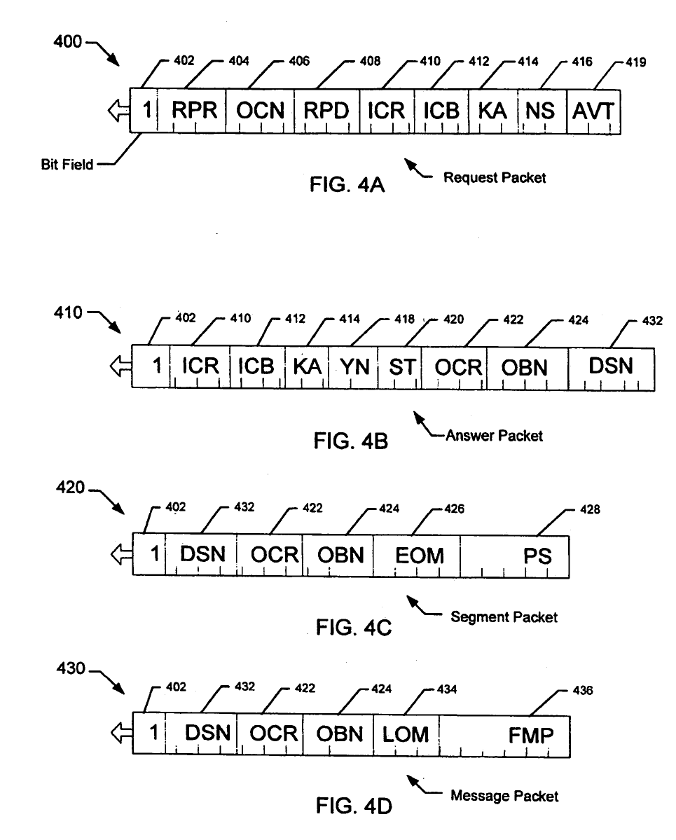

FIGS. 4A, 4B and 4C show diagrams of the information packets used by the switching system. Table 1 gives a brief overview of the various fields in the information packets.

TABLE 1

| | |
|---|---|
| AVT | A list of times that are available for the input controller to inject |
| | the message into the data switch. The length of this field |
| | depends on the encoding strategy employed and a design |
| | parameter NTI. |
| BIT | A one-bit field set to 1 to indicate the presence of a packet. |
| DSN | Used in embodiments such that: 1) there is more than one data |
| | switch and 2) a given message packet segment does not go |
| | through all of the data switches. DSN indicates which data |
| | switch or set of data switches will carry the segments of the |
| | message packet. |
| EOM | End Of Message packet indicator. A one-bit field that is set to |
| | one if the segment being sent is the last one of the current |
| | message packet. Otherwise, it is set to 0. |
| FMP | The length of the full packet used in non-segmented packet |
| | embodiments. |
| ICB | The bin number used by the AS2 Answer Switch to send an |
| | Answer Packet back to the Input Controller that made the |
| | request. |
| ICR | The ring number on Level 0 of the AS1 Answer Switch |
| | associated with the Input Controller that sent the request. |
| | Combined with the ICB field, the two will uniquely locate the |
| | path to the requesting Input Controller. |
| KA | Address of a packet KEY in the Keys Buffer. It is a unique |
| | packet identifier relative to a given Input Controller. |
| LOM | The length of a data packet (in segments) used in embodiments |
| | that send un-segmented data packets to the data switch units. |
| NS | The number of segments of a given packet stored in the Input |
| | Packet Buffer of the requesting Input Controller. |
| OBN | The bin or buffer in the DS2 Data Switch designated to receive |
| | the Segment Packets for a given message. Each bin is |
| | associated with only one Output Controller. |
| OCN | The number that a Request Processor associates with a |
| | particular Output Controller under its control. If a Request |
| | Processor controls only one Output Controller, OCN will be |
| | ignored. |
| OCR | A ring number at Level 0 of the DS1 Data Switch designated to |
| | receive Segment Packets destined for a given Output Controller |
| | or set of Output Controllers. |
| PS | The payload section of the segment of a message packet. |
| RPD | Request Processor Data used by a Request Processor to |
| | determine which packets to send through the Data Switch |
| | System. QOS (Quality of Service) information would be |
| | included in this field. |
| RPR | The ring number at Level 0 of the Request Switch that serves a |
| | given Request Processor. Each Input Controller contains a |
| | table that associates an RPR value with each Output Controller. |
| ST | The beginning of a packet sending cycle designated by a |
| | Request Processor for an Input Controller to begin sending the |
| | first segment of a message packet. In one embodiment, all |
| | remaining segments of the packet are sent sequentially in the |
| | NS-1 packet sending cycles that immediately follow ST. |
| YN | Permission or denial for sending a message to the Data Switch |
| | System. The value 1 designates approval and 0 designates |
| | denial. |

The request packet 400 is created by the input controllers and sent to the appropriate request processor through the request switch. The BIT field 402 is always set to 1 to indicate the presence of a packet. The RPR 404 field is the address of the request processor that will handle the packet. Since in some embodiments a single request processor may handle requests for a plurality of output controllers, an output controller number OCN 406 is supplied to the request processor. Processors that handle packets for only one output controller ignore OCN. The RPD field 408 supplies data (such as QOS) used by the request processor to help decide which requests to approve. Since, in some embodiments, all segments are approved by a single request, NS 416 gives the number of segments in the message packet. Using NS, the request processor can schedule the number of sending cycles required to send all the segments of the message through the data switch system in those cases where there are no time gaps allowed between segment insertion times. ICR 410 and ICB 412 give the ring number on AS1 and the bin number in AS2 needed to return the answer packet to the sending input controller. The key buffer address KA 414 is returned in the answer packet as a unique message identifier for the input controller. AVT indicates acceptable message injection times.

In the simplest embodiment, the field AVT 419 holds a sequence of non-overlapping time intervals that are available for message injection into DS1. The maximum number of intervals in the sequence is fixed by the design parameter NTI. Suppose that NTI=3 and at time t₀, the input controller sends a request packet to schedule a message with 5 segments (NS=5). An example of one possible AVT field is as follows: AVT={[t₀+50, t₀+70], [t₀+80, −1], [−1,0]}, where a −1 in the second entry of a pair indicates infinity and a −1 in the first entry of a pair indicates that the pair contains no data. Thus, the indicated time intervals are [t₀+50, t₀+70], and [t₀+80, ∞]. In this example, AVT indicates that the message injection time can begin at a time t such that 50≦t≦66 or 80≦t.

The answer packet 410 uses the ICR and ICB fields to return the answer to the sending input controller. YN 418 is the one bit answer, set to 1 for yes and 0 for no. The KA, ST, OCR, OBN and DSN fields are used by the input controller. KA uniquely identifies the message to be sent to the data switch, while OCR 422 gives the target output ring of DS1 and OBN 424 gives the target output port (bin) of DS2. ST 420 tells the input controller when to begin sending the first segment of the message. In embodiments where multiple DS1 data switch modules are employed and there is no sub-segmentation, the data switch number DSN identifies which of the DS1 data switches is to be used by the message.

The segment packet 420 used in this embodiment is relatively simple. DSN identifies the proper DS1 subunit to carry the packet. OCR is the target output of DS1 and OBN is the target output of DS2, and EOM 426 is an end-of-message indicator set to 1 on the last segment packet of the message and set to 0 on all other packets. PS 428 is the payload of the segment packet.

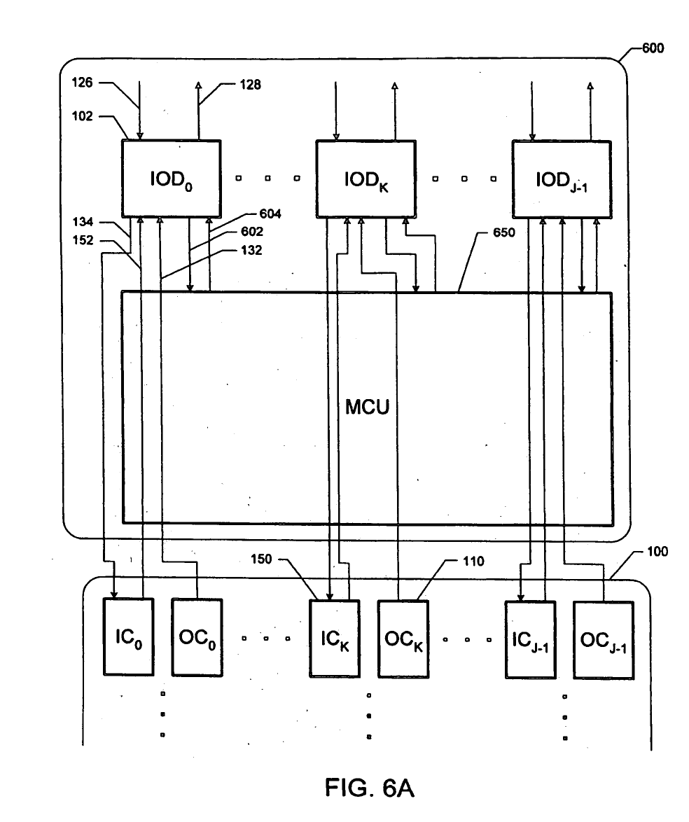

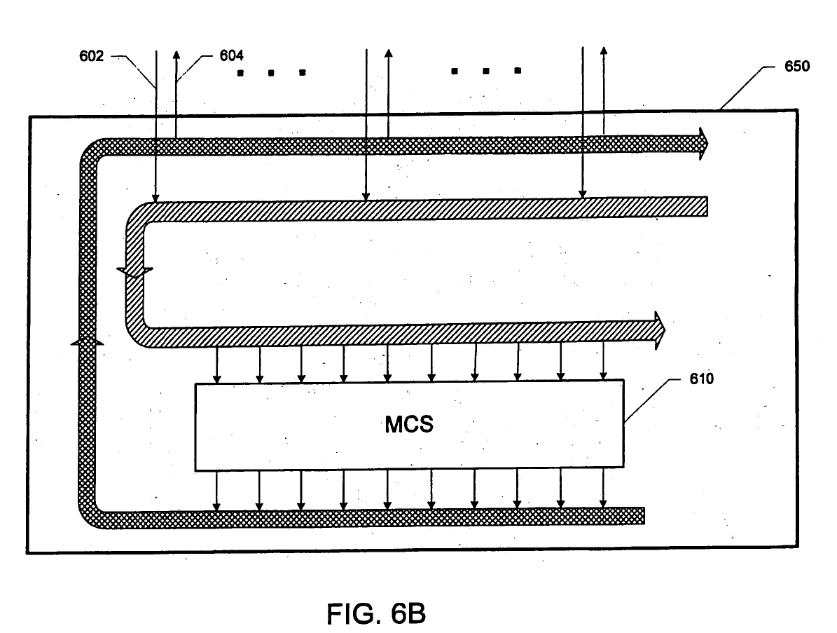

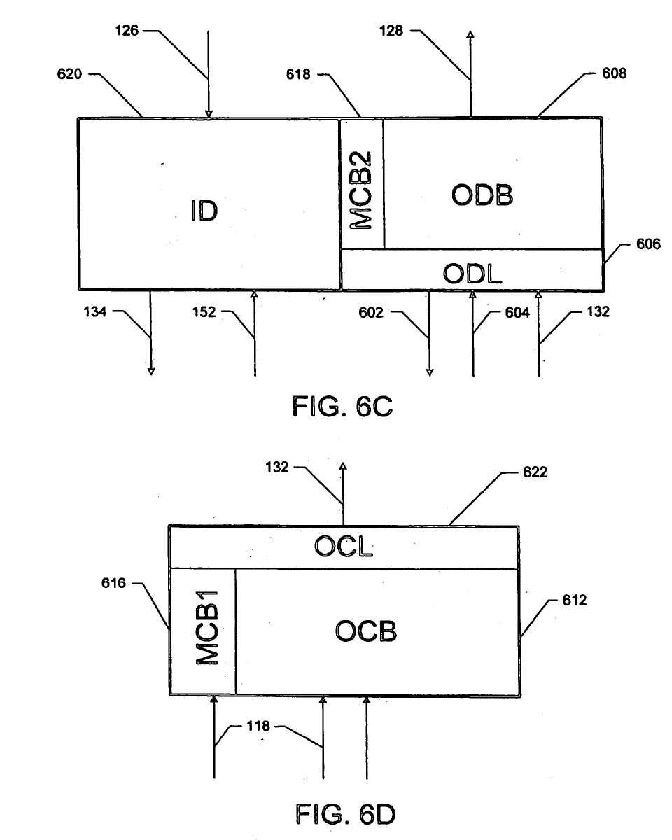

FIG. 6A, FIG. 6B, 6C and 6D illustrate a method for sending a single data packet to multiple output devices, i.e. multicasting. A multicasting embodiment of the current invention has an input/output subsystem 600, which contains J I/O devices 102, labeled IOD₀, IOD₁, . . . , IOD_{J-1}, and a multicast unit MSU 650. Suppose that the set of output devices are decomposed into groups and that IOD_{K} is the representative member of the group G. In one embodiment, the changing of the members of the groups is a relatively infrequent event. Additional details of IOD_{K} 102 are illustrated in FIG. 6C and show that IOD_{K} contains an input device section ID 620 and an output device section (which consists of items 606, 608 and 618). As in other embodiments of the switching system 100, message packets are sent for processing from ID to its corresponding input controller IC_{K} 150 via line 134. Multicast message packets will contain information indicating the representative member of the group.

Request packets for a multicast message (not illustrated) will be addressed to the representative member of the group and will be flagged for multicasting by the input controllers. When the request processor RP_{K} 106 (which controls the flow of data to OC_{K}) detects the multicast flag, it directs the packet to a special multicast bin MCB1 616 in the output controller buffer OCB 612 (Refer to FIG. 6D). When the output controller OC_{K} 110 sends this packet to IOD_{K}, the packet is directed to a special multicast bin MCB2 618 in the output data buffer ODB 608.

The output device logic ODL 606 has access to addressing information for each member of the group G. When ODL processes a message packet from MCB2, it does two things: 1) ODL sends the packet out of IOD_{K} via line 128, and 2) ODL sends a copy of the packet via line 602 to the multicast switch MCS 610 (illustrated in FIG. 6B). MCS is set so that the received message from MCB2 is sent to each member of G other than IOD_{K}. MCS directs each of the packets though lines 604 to the designated output device where it is placed in the output data buffer as an ordinary message packet (i.e. not in the multicast bin). In due time, all the packets for G are sent out of the I/O devices via line 128, thus completing the multicasting process. The multicast switch MCS can be a crossbar with fan-out. In this case, all of the packets are sent from MCS through lines 604 at the same time.

In an alternate embodiment, there are special multicast packet sending times and IOD_{K} does not immediately send the multicast packet out of line 128. The message to be multicast is sent to all of the members of the group at the same time.

In another multicasting application where a packet is to be sent to a group of destinations, but the group is not defined as a special multicast group as in the previous discussion, the input controller can make individual requests to send each of the packets and then send them out as scheduled. The fact that the input controllers have multiple paths to the data switch and the data switch has multiple paths to the output controllers makes the system disclosed in the present invention ideal for multicasting messages to groups of outputs that are not set for long durations of time.

Device Boundaries

The system of the present invention can be constructed using a number of technologies, including optical and electronic. In reference to FIG. 1A, in one embodiment, each of the I/O devices is either on a separate 10 board or else a plurality of these devices are on a single board. The entire system 100 can either be on a single chip or else the data switches 140 can be on one chip and the control section 120 can be on a second chip or on a set of chips. In another embodiment, a portion of the input controller function can be included on the I/O device (where the I/O device can be a line card). In particular, the input buffers can be shared between the input controllers and the line cards, and the output buffers can be shared between the output controllers and the line cards. It may be useful to place one or more input controllers or output controllers on a separate silicon chip. One skilled in the art will find a number of effective ways to effectively place the system on one or more chips. The interconnect lines between modules can be either optical or electronic. The switches can be either optical or electronic. Moreover, the modules themselves can be made using a wide variety of technologies or mix of technologies including, but not limited to, optics and electronics. In one embodiment, a portion of the modules in system 100 may be built using standard silicon while other portions can be built using other technologies, such as GAS. A portion of the system may be built in a very low temperature technology. Three schemes utilizing different device boundaries are depicted in FIG. 7A, FIG. 7B and FIG. 7C.

FIG. 7A is a schematic diagram of an embodiment of this invention that uses multiple copies of the switching system 100. In it there are J I/O devices 102, denoted by IOD₀, IOD₁, . . . , IOD_{J-1}, and K copies of the control and switching system 100, denoted by S₀, S₁, . . . , S_{K}. Each I/O device divides incoming packets into K smaller packets and sends them into the set of input controllers associated with the switching systems 100. As previously described, each system S processed its sub-packet and sends it to the destination I/O device both fully reassembled and at a prescheduled time. This process facilitates the destination I/O device in the reassembly of the K smaller packets for sending to the output line 128.

FIG. 7B is an embodiment where there are multiple copies of the data switch 140 with each data switch consisting of the data switches DS1 146 and DS2 144. In a first embodiment an input controller divides each data packet segment into K sub-segments (where there are K copies of the data switch) and simultaneously sends one of the sub-segments through each of the data switches. In a second embodiment, an input controller does not divide the packet segments into sub-segments but instead sends all of the segments of a given message through the same data switch. In the second embodiment, the request processor sends an answer packet with all of the aforementioned data along with information as to which of the K data switches the message is to travel through. In the second embodiment, there needs to be a method of delivering the message packet segments to the proper data switch. This can be accomplished by a small switch (not pictured) between each input controller and the input ports of the data switches. In case multiple copies of the data switch are employed and sub-segments are not employed, a system pictured in FIG. 7C is ideal.

An embodiment illustrating an alternative device boundary structure is illustrated in FIG. 7C. This embodiment is ideal when parallel data switches are employed and where there is no sub-segmentation. In this embodiment, there are multiple line cards. A portion of the output controller functions and input controller functions are performed on the line cards. In this embodiment, there is one copy of each of the request processors. The request processors, the request switch and the answer switch are on one or more chips. The data switch is on a separate chip from the request switch, the request processors, and the answer switch. In the embodiment, illustrated in FIG. 7C, the input controller functions are divided between those input controller functions that are performed on the line cards and those input controller functions that are performed on the data switch modules. The portion of the input controller that is on the line card is referred to as ICL 732. The portion of the input controller that is on a data switch module is referred to as ICS 734. The output controller is also physically subdivided between a portion of the output controller OCL 736 on a line card and a portion of the output controller OCS 738 that is on a data switch. There is a plurality (stack) of data switch modules each consisting of the four units ICS, DS1, DS2, and OCS.

Sending Full Packets through Parallel Data Switches

The method of sending of full packets without segmenting through the data switch system 730 illustrated in FIG. 7C will now be disclosed. In FIG. 7C multiple data switch modules are employed. The disclosure presented in this section treats the general case employing multiple data switch modules. The techniques of this section work equally well when only one data switch module is used. When a message arrives on a line card, ICL builds a request packet and submits the request to the request subsystem 120 composed of the request switch, the request processors, and the answer switches. The request processor associated with the message packet target output returns an answer packet to the ICL unit sending the request. The answer packet contains the field DSN 432 indicating which of the data switching modules will receive the packet. In case there is only one module, this field can be left blank in the answer packet. The input controller ICL sends the message packet 430 to the data switch module designated by the DSN field of the answer packet. Multiple messages in the line card can be switched to their proper data switch module input ports through a crossbar switch (not pictured) located within ICL. The DSN field is discarded prior to the sending of the message packet through the interconnect line 116 to the data switch module. In this embodiment, the FMP field 436 contains the entire payload. The LOM field 434 contains an integer that indicates the length of the message packet. The OCS module uses this number to reassemble the message from the segments. The message packet travels to the ICS module located on the data switch. The ICS module is responsible for segmentation of the packet. When the ICS module receives the message, it stores the OCR, OBN and LOM fields. Then the ICS constructs and sends the segment packets through the data switches. Each time a segment packet is sent, the LOM value is decremented so that when the last segment is constructed, the proper value of EOM can be placed in the header.

The segment packets pass through the switch through the proper level 0 ring of DS1 as indicated by the OCR field. The OCR field is discarded one bit at a time as the message makes its way through DS1. The switch DS2 sends the packet to the proper OCS output bin as indicated by the OBN field. When the entire packet arrives at the output bin (as indicated by the EOM field, the OCS forwards the entire reassembled message packet to OCL. The OCL logic forwards the packet to the IOD output device and the message leaves the switch through line 128.

Timing Considerations

The systems disclosed in the present invention and illustrated in FIG. 7C are designed to tolerate timing jitter. In the present invention, modules on separate chips send information indicating message time injection. These message injection times are based on a clock that moves one step forward in the time that it takes an entire message segment to flow by a point in the DS1 module. The injection itself occurs on still another chip. This requires that each chip has a copy of the same clock. The clock is a counter that counts with a modulus of sufficient size so that no future referred time is ambiguous. It is important that the message segments arrive at the ICS 734 module prior to its injection time as referenced by the clock that controls the DS1 and DS2 switches. But buffers in the ICS module allow for the arrival time of the message onto the chip to be slightly ahead of the actual injection time, thereby avoiding the problem of an error due to clock skew.

Alternative Message Segment Sequencing Embodiment

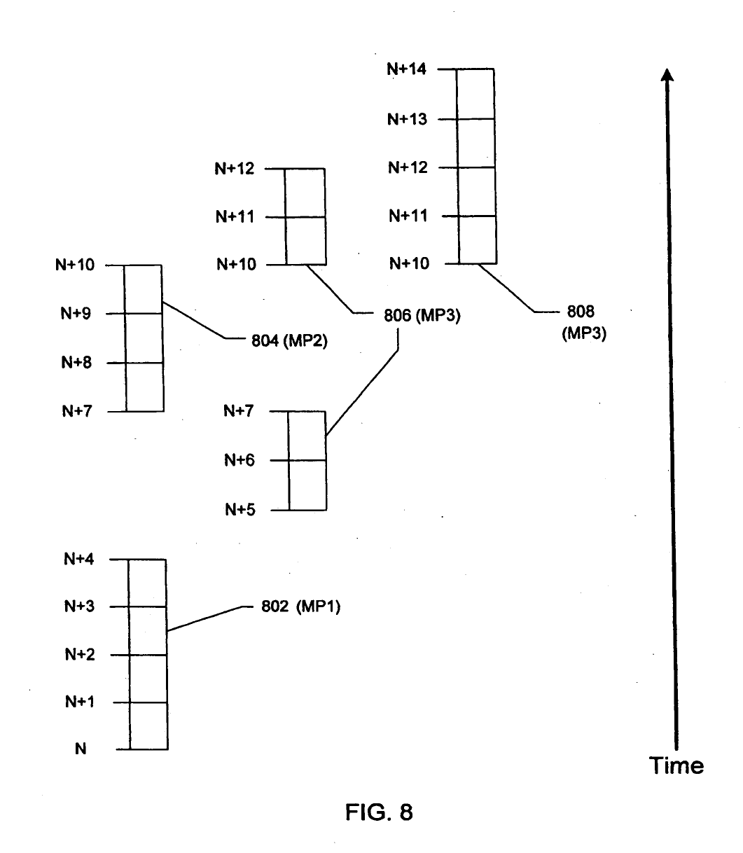

In a first embodiment described above, message segments are sent in sequential fashion with no time gaps between the segments. In the alternate second embodiment using message segment sequencing presented in this section, the segments of a given message are sent to the data switch in sequential order, but there may be gaps of various lengths between the segments. This concept was first introduced in patent No. 8. In the present patent, the alternative message segment sequencing embodiment additionally includes the reservation of a bin to receive the segments of the packet. Refer to FIG. 8, which illustrates two message packets MP1 802 consisting of four segments and MP2 804 consisting of three message segments that have entered the system through the same input device IOD_{K} and are scheduled to be injected into the structure 720 (consisting of DS1 and DS2) by IC_{K} at the two times N and N+7 in the future. Now suppose that a third message packet MP3 806 targeted for IOD_{T} and consisting of four segments enters IOD_{K}. In response to the entrance of MP3, IC_{K} sends a request packet to RP_{T} asking for a scheduling time for the injection of MP3 into the data switching structure 720.

In the first embodiment that does not allow time gaps between inserted segments of a message, IC_{K} sends a request packet to RP_{T} with an AVT field indicating future times when it has available inputs to inject all of the segments of MP3 with no time breaks between segment insertion times. Thus, in the first embodiment, IC_{K} informs RP_{T} that it is able to inject at time N+10 or later. This AVT is set to {[N+10,−1],[−1,0],[−1,0]}. In the embodiment of the present section, RP_{T} has an AVT field set to {[N+4,N+7], [N+10,−1],[−1,0]}. The request processor RP_{T} that receives the request with the AVT field will respond based on the condition of the future availability of data carrying lines and bin availability. Suppose that, based on previously scheduled messages into DS2 bins designated for IOD_{T}, the receiving lines (lines into a single message receiving bin) are available for all times beginning with time N+5. Then in the first “no time gap embodiment” MP3 segments will be scheduled according to the time illustration 808 of FIG. 8 and the second “gaps allowable embodiment” the message MP3 segments will be scheduled according to the time illustration 806.

In the first triplet, the integers N+4 and N+6 indicate that N+4, N+5, and N+6 are acceptable starting times, the integer 7 in the third position indicates that if any of these starting times is used, then it will be necessary that the receiving bin in OCS be available for seven consecutive receiving times. The second two triplets in the second embodiment convey the same information as the first two triplets in the first no-time-gap embodiment.

The request processor RP_{T} that receives the request with the AVT field will respond based on the condition of the future availability of data carrying lines. Suppose that, based on previously scheduled messages into DS2 bins designated for IOD_{T}, the receiving lines (lines into a single message receiving bin) are available for all times beginning with time N+5. Then in the first “no time gap embodiment” MP3 segments will be scheduled according to the time illustration 808 of FIG. 8 and the second “gaps allowable embodiment” the message MP3 segments will be scheduled according to the time illustration 806.

In systems of the type illustrated in FIG. 7C it may be necessary to have multiple AVT fields. This topic is discussed in the next section.

Hybrid Parallel Data Switch Embodiment

In systems of the type illustrated in FIG. 7C and FIG. 7D, which employ a large number of switching modules 720, sub-segmenting the data so that a sub-segment passes through each of the switches is not maximally efficient because the ratio of header to payload is too large. On the other hand, avoiding sub-segmentation entirely is not maximally efficient for a number of reasons, including the increased computational burden placed on the request processors. In case neither of the first two embodiments is maximally efficient, one can employ a third embodiment wherein each segment is sub-segmented with the number of sub-segments greater than one but less than the number of switching modules 720. In this embodiment, consisting of NM modules, the modules are subdivided into NM1 groups each consisting of NM2 modules so that NM is the product of NM1 and NM2. Each segment is divided into NM2 sub-segments. For each segment of a given packet, the NM2 sub-segments pass through separate switches and each segment passes through only one of the NM1 available switch system groups. The AVT field contains NM1 entries with each entry consisting NTI time interval fields. The request processor returns a value of 0 to NM1-1 in the DSN 432 field. Consider the embodiment where all segments of a message packet are sent continuously (without time gaps) all of the segments are stored in the same bin. In this embodiment, it may be convenient for the bin to be divided into NM1 sub-bins with each of the data switch modules feeding one of the sub-bins. This will conveniently allow parallel transfer of packets from OCS 738 to OCL 736. An illustrative example will now be given.

For our example, assume that there are eight data switching modules. Suppose moreover, that the modules are divided into two groups each consisting of four modules (NM=8, NM1=2, NM2=4). In our example the bottom four switching modules are in group 0 and the top four modules are in group 1. Separate AVT available time intervals must be given for each group so that AVT₀ corresponds to group 0 and AVT₁ corresponds to group 1. Now suppose, in our example, that a message packet MP consisting of 22 segments arriving at input controller IC_{U} is destined for output controller OC_{V}. Responsive to the arrival of MP, IC_{U} sends a request packet to request processor RP_{V}. In the request packet 400, RPR and OCN identify RP_{V}, ICR and ICB identify the input controller IC_{U}, the number of segments NS is set to 22 and AVT is composed of AVT₀ and AVT₁ where, for this example, AVT₀={[N+15, N+40], [N+50, N+100], [N+200, −1]} and AVT₁={[N+30, N+60], [N+70, −1], [−1,0]}. Request processor RP_{V} has stored in memory all of the times that messages have been scheduled to enter the various output controller bins. Request processor RP_{V} has also stored in memory the amount of available output controller data space. Based on this information and in the information contained in AVT₀ and AVT ₁, and the information contained in all competing request packets, the request processor determines whether or not it is possible to schedule the message within the acceptable maximum time limitation. If such scheduling is possible, the request processor schedules a bin to receive the message packet and a time for the input controller to begin inserting the message packet into the data switch. The request processor RP_{V} sends an answer packet 410 to IC_{U}. This answer packet indicates the proper output ring OCR and bin OCB to receive the packet through the proper switch or switch bank DSN. In yet another embodiment, different data switches can be designed to take packets of different lengths. There are a number of applications that can be based on this embodiment. In one application, one of the switches can take packets of length 64 bites while another switch accepts packets of 80 bites. One skilled in the art will immediately see a number of ways to design switches that can be reconfigured to accept various segment lengths. In one such embodiment, one or more of the data switches can be configured to accept packets of the maximum length while other switches are configured to accept packets of the minimum length.

Software System Flexibility

Refer to FIG. 1A in conjunction with FIG. 7B and FIG. 7C illustrating a number of modules including the input controllers 150, the output controllers 110, and the request processors 106. In a first embodiment, the logic performed by these three modules can be built into the hardware. For example, the request processors can use a data base that contains counters that are incremented by an integral amount when a packet is scheduled and decremented by one at each segment sending time. In a second embodiment, the logic can at least in part depend upon software loaded into these units by a system processor (not illustrated). In a third embodiment, these units can contain programmable gate arrays whose function depends on data that is loaded into the modules at the time that the device is powered up. In a fourth embodiment, the function of the modules can depend upon both programmable gate arrays and upon software. Moreover, referring to FIG. 4A, the data in the RPD field 408 of the request packet 400 can carry data of different types depending on the configuration of the input controllers and the request processors. The RPD field can be of a length so that additional information can be added or the size of this field can be a variable depending on system configuration. The RPD field can contain information based on QOS, length of time since the message was sent and amount of data in the input controller buffer. Moreover, the answer packets can contain information not contained in the fields illustrated in FIG. 4B. This system flexibility enables the system to adapt to changing network standards.

Hardware System Flexibility

An embodiment of a switching system with hardware flexibility is illustrated in FIG. 7D, in conjunction with FIG. 7E and FIG. 7F. The system illustrated in FIG. 7D is equipped with “plug in” modules illustrated in FIG. 7E and FIG. 7F. Each of these modules is capable of being coupled to an input/output device either of the type illustrated in FIG. 7E or of the type illustrated in FIG. 7F. In this way, one basic system can be used in a number of ways, e.g. a single high speed box could be configured to be a metropolitan area network router, a core edge router or a core router; a single smaller box could be configured as an interconnect switch between workstations, as an access router, or as a metropolitan area network router.

As before, the input controllers ICL send a request for each arriving message. The messages can originate from different locations as illustrated in FIG. 7E or all come from the same location as illustrated in FIG. 7F. In the OCN field 406, the request packet contains an output port identifier. There exists a set of output bins that are capable of send messages to the port identified by the output port identifier. This association is enabled by a software setup routine that is run when this port is plugged into an input/output socket 742. As before, the request processor schedules an output port bin for a message, as well as a time for sending it.

The switching system can be configured with some, but not all, of the input/output sockets occupied. In this case, it may be economical to for only a subset of the data switch modules to be in place (with each module consisting of one ICS, one DS1, one DS2 and one OCS unit). Each of the data switch modules consists of a single chip (or multiple chips in an alternative embodiment). It is therefore easy to scale up the system by adding additional data switches modules. When a module is added, there is a software update to the request processors so that the request processors can schedule data to pass through the added switch or switches.

Actions are instigated by the input port. When a message arrives, the input port sends a request to schedule the sending of the message through the data switch. When all requests have been granted or denied, no communication between the input port and the rest of the system takes place. Therefore, no interrupts take place when an input/output device is removed from the system. A new input/output device can be inserted to the system once the software in the request processors identifies the new device. For this reason, it is not necessary to shut down the system when changes are made in the input/output devices. This ability to “hot swap” devices is extremely desirable and is a natural feature of the system.

In some applications, a portion of the plug in modules may not be ports leading to other switches but may instead be attached to devices such as computers or mass storage devices. Such connected devices could enable higher layers of service. For example, a mass storage device could be used to store a wide variety of data objects including frequently requested web pages. In this case, the storage of the data is accomplished by sending the data out the port and the acquiring of data is achieved by sending a message to the port. This type of flexibility of use is made possible by the flexibility of hardware and software employed in the request processors.

Request Processor Embodiments

A given request processor can control the flow of data to one output controller or to a plurality of output controllers. In one embodiment, the number of request processors is equal to the number of I/O devices and request processor RP_{X} is associated with IOD_{X}. The I/O device IOD_{X} can receive and send data from a single external device via a single high bandwidth line or IOD_{X} as illustrated in FIG. 7F. In this case RP_{X} schedules data for a single line card. The I/O device can also receive data from a plurality of external devices via multiple lower speed lines as illustrated in FIG. 7E. In this case the RP_{X} schedules data for multiple line cards. In the first case, the request processor has more freedom in assigning bins to receive a message. The request processor function can be governed by software that matches the number and the bandwidth of the lines to and from the I/O device. The request processor can also be governed by the setting of field programmable gate arrays that are loaded dependent on the configuration of the I/O lines.

In another embodiment, the request processor is a part of the output control logic device 736. In this case, the lines 105 still extend from the request switch to the request processor and the lines 107 still extend from the request processor to the answer switch.

In a first embodiment, in response to a request packet, a request processor either schedules the packet for entrance to the data switch or denies entry. In this embodiment, the input controller can make another request to schedule the packet at a later time. In a second embodiment, the request processor contains memory for storing a request so that the request processor can, at a later time, invite the input controller to resubmit the request by sending available times for injecting the packet.

There are a number of strategies that increase the probability that a request processor is able to schedule the high priority messages. One strategy is that special bins and lines through the switch are reserved for higher priority messages. The request processor can reserve a portion of the lines 116 and 118 for high priority messages. Additionally, the input processor can reserve lines 116 as well.

Another strategy that increases the probability that a request processor is able to schedule high priority messages is to allow the request processor to schedule high priority messages at later times in the future than low priority messages. As one example of this type of strategy, low priority messages that cannot be scheduled within a certain short time span must be discarded whereas higher priority messages can be scheduled at times further in the future. In this way, the future times are guaranteed not to be occupied by a low priority message. Additionally, a strategy that combines the time slot reservation and the line and bin strategy can be employed. In this way, the device illustrated in FIG. 7C becomes a hybrid data storage, data processing, and data switching system.

Increased Data Rate between Nodes

One method of increasing the data bandwidth between nodes is accomplished by utilizing busses between nodes as illustrated in FIG. 5. In this embodiment, the latency of the first header bit (the timing bit or “here I am” bit) through the switch is the same in an embodiment utilizing busses as in the embodiment utilizing a single line, however, the latency between the time that the first header bit enters the switch and the time that the last data bit enters the switch is shorter. Therefore, the number of messages that can be injected into DS1 is increased. This has a number of advantageous consequences. The size of the data switch can be decreased so that a level can be eliminated. Moreover, in some cases, the number of data switches illustrated in FIG. 7D can be decreased without decreasing bandwidth.

Another method for increasing data bandwidth between nodes is to send data bits through a line at a higher rate than header bits. This is possible because the node logic is not in operation when the data portion of the packet is passing through the node. The advantages of this method are the same as the advantages for the bus between nodes. Moreover, the additional data lines between nodes embodiment can be used in conjunction with the increased data rate per line embodiment.

Alternative Scheduling With Request Processor Buffering

The previous section taught the method of scheduling a message to be sent through the switch by scheduling groups of segments to enter the switch at various times. In an alternative embodiment disclosed in the present section, a similar method of scheduling portions of the message to enter the switch at various times will be handled in another way. A message with a given message identifier is stored in an input buffer or in an input controller buffer while a request packet is sent to the request processor. Responsive to the receipt of the request, the request processor attempts to schedule the entire message to be sent at some future time. This may not be possible because there is an upper bound on how far in the future a message may be scheduled. In some instances, there is an acceptable time to schedule a portion of the segments for entry into the switch. In this embodiment, the request processor schedules a portion of the message to be sent at a given time and delays the scheduling of the remainder of the message. There are numerous ways accomplish this task. The details of one method follow.

Consider a message packet MP consisting of segments S₀, S₁, . . . , S_{U-1}. MP is stored in an input buffer or input controller buffer. A unique message identifier is stored in the previously mentioned storage area KA. In case the request processor cannot schedule all U of the segments, but can schedule a smaller number P of segments at times consistent with AVT, then the request processor does so and reserves a bin OBN to receive all U of the segments. The request processor returns the integer P in a field not illustrated in FIG. 4A. At the scheduled time, the input controller sends the segments S₀, S₁, . . . , S_{P-1} and keeps a copy of all of the segments S₀, S₁, . . . S_{U-1}. The request processor schedules the first P to enter the switch at a time that agrees with the AVT data in the request packet. In addition to the usual information in the answer packet, the answer packet contains the integer P and also schedules a bin OBN to receive the entire message. The request processor stores unique message identifier KA for the partially accepted message. At a later time, the request processor may request to send the remaining segments of the message. If after a certain time interval, or other limiting bound, the scheduling of the entire message has not been completed, then the bin designated to receive the entire message packet is made available for other messages.

A 72 Port Switch Example

Following is a description of how a 72-port access switch can be constructed by methods taught in this invention. It is for illustrative purposes only and does not necessarily represent the way in which such switches will actually be constructed. One skilled in the art could easily use the ideas taught in this invention to construct this switch, or one with a higher number of ports, in alternate ways.

This switch will contain 64 “low-speed” ports (e.g. 10/100 Ethernet) and eight “high-speed” ports (e.g. Gigabit Ethernet). Referring to FIG. 1A, such a system would have 72 I/O devices IOD₀, IOD₁, . . . , IOD₇₁; 72 input controllers, IC₀, IC₁, . . . , IC₇₁; and 72 output controllers OC₀, OC₁, . . . OC₇₁. It is assumed that the 64 low-speed input ports are numbered 0 to 63 and the eight high-speed ports are numbered 64 through 71. A suitable MLML request switch might contain eight levels with 128 rings at Level 0. A desirable MLML switch would be a “flat latency” or “double down” switch of the type taught in patent No. 2. Each low-speed I/O device will have a single input port into RS, while each high-speed I/O device has eight dedicated input ports into RS. In this way, 64 of the 128 RS input ports are dedicated to the low-speed lines and the remaining 64 input ports of RS are dedicated to the high-speed lines. There will be 72 request processors, RP₀, RP₁, . . . , RP₇₁, with the first 64 request processors each fed request packets by a single corresponding ring at the bottom level of the request switch and the remaining eight request processors each fed by eight rings at the bottom level of the request switch. Each request processor will serve one output port. RP₀ through RP₆₃ will serve low-speed ports, while RP₆₄ through RP₇₁ will serve the high-speed ports.

The first answer switch AS1 will also be an eight level MLML switch. In each request cycle, each request processor is allowed to submit no more than a fixed number of requests, and therefore, AS1 can be a stair-step MLML switch of the type taught in patent No. 3. It will also consist of eight levels with 128 rows at Level 0, denoted by AR₀, AR₁, . . . , AR₁₂₇. Each low-speed request processor has only one input port into AS1, while each high-speed request processor has eight input ports into AS1. However, since a given low-speed port may have multiple answers to send, an additional process must be available. In a first embodiment, there are multiple answer sending cycles during a request sending cycle. In a second embodiment, a concentrator of the type taught in patent No. 4 is used. In a third embodiment, similar to the second embodiment, the answer switch may have a decreasing row count structure of the type taught in patent No. 3.

This architecture with these parameters can be built with or without the answer switch AS2. If AS2 is employed, it is composed small crossbar switches, with each switch having the same number of inputs as there are outputs on the bottom ring and also having as many inputs as the allowable number of requests per cycle. In this manner, all answers are returned to the proper input controller.

In this embodiment, the data switch DS1 contains is an MLML switch with nine levels and 256 rows at Level 0. Of these rows, 128 will be used for the low-speed ports (with two rows for each port) and 128 of the rows will be used for the high-speed ports (with 16 rings for each port). The request processor will allow each low data rate port to inject no more than two segments at a given injection cycle and will allow a high-speed port to inject no more than 16 segments in a given cycle. If each ring has five output ports with only three hot, then a maximum of six segments can arrive at a given low-speed port at a given time. The request processor will allow a high-speed port to receive a maximum of 48 segments at a given time. Each bottom row will be connected to one 5×3 crossbar switch.

If such a chip were constructed with 200 MHz pins, then there would need to be 5 input pins and 5 output pins for each high-speed port with a single pin supporting two low-speed input ports and a single pin supporting two low-speed output ports. Since this chip count is modest (128 data pins and possibly another 100 pins), it would be possible to build such a chip with twice as many data output ports as data input ports (196 data pins and roughly another 100 pins), thereby lessening the demand on the output controller buffer area. Since there are relatively few output port pins and since the total data through these pins is light, the power consumption of such a chip would be minimal. Given the “over-engineering” of the chip, there would be very little data discarded on the input port side or in the output controller buffers. Some discarding of messages might occur on the output side of the I/O devices.

Other Applications

In a parallel computer application, processors with multiple input ports can request data to be delivered to a pre-assigned input port. The processor receives its data from a given ring (or collection of rings) on the bottom level of an MLML switch DS1 146, and the data is delivered to the proper processor port by switch DS2 144.

In all data movement applications where it is convenient for a single output of a given data switch DS1 to feed a plurality of specific target devices, the use of a second data switch DS2 is useful. When a specific target device has an input bandwidth greater than the output of a given data switch DS1, the techniques of FIG. 2B can be employed effectively.

While the invention has been described with reference to various embodiments, it will be understood that these embodiments are illustrative and the scope of the invention is not limited to them. Furthermore, the system is defined using directional terms such as “top”, “bottom”, “left” “right” etc. This terminology is included only to assist in the understanding of the illustrative embodiments. No actual directionality is implied. Many variations, modifications, additions and improvements of the embodiments described herein are possible. Furthermore, many different types of devices can be constructed using the interconnect system, including (but not limited to) workstations, computers, processors in a supercomputer, terminals, ATM switches, telephone central office equipment, Ethernet switches, Internet protocol routers, access routers, LAN routers, WAN routers, enterprise routers, core edge routers and core routers. Variations and modifications of the embodiments disclosed herein may be made based on the description set forth herein, without departing from the scope and spirit of the invention as set forth in the following claims.

We claim:

1. An interconnect structure S having a plurality of input ports including the input port IP and a plurality of output ports and a logic RP such that for a message packet MP arriving at IP, the said logic RP scheduling a present or future time for all of MP to enter S with the scheduling based at least in part on the priority of the message packet MP.

2. An interconnect structure in accordance with claim 1 in which the priority of MP is based at least in part of the quality of service of the message MP.

3. An interconnect structure in accordance with claim 1 in which the message packet MP is divided into segments and a logic RP schedules multiple times for a plurality of segments of MP to enter the interconnect structure S.

4. An interconnect structure in accordance with claim 1 wherein the logic RP schedules the entrance of MP into based at least in part on a condition at the target output port of MP.

5. An interconnect structure in accordance with claim 4 in which there is a buffer at the target output port of MP and the logic RP that schedules the inputting of MP into S is based in part on the contents of said buffer.

6. An interconnect structure in accordance with claim 1 including an input port IQ distinct from the input port IP with the scheduling of MP based at least in part on the conditions at input port IQ.

7. An interconnect structure in accordance with claim 1 including an input port IQ distinct from IP and output port O of the plurality of output ports wherein the logic RP schedules a message MP at input port IP and a message MQ from input port IQ to enter the output port O in such a way that for some time T, both MP and MQ are entering O at time T.

8. An interconnect structure in accordance with claim 7 wherein the output port O has an associated buffer OB with OB containing a plurality of sub-buffers referred to as bins including the bins BP and BQ wherein RP schedules MP to enter BP and schedules MQ to enter BQ.

9. An interconnect structure in accordance with claim 8 wherein MP is subdivided into a set of segments and MQ is subdivided into a set of segments and all of the segments of MP are scheduled to enter BP and all of the segments of MQ are scheduled to enter BQ.

10. An interconnect structure S in accordance with claim 1 wherein multiple paths exist for MP to travel from its input to the target output and the logic RP schedules a portion of the path for MP.

11. An interconnect structure in accordance with claim 1 including the output port OP with a buffer OB at OP and a logic RP such that for a message MP arriving at IP, the logic RP assigning a storage location SL in OB so that the message MP will be stored in SL.

12. An interconnect structure S in accordance with claim 11 in which the message MP has a header and there being a method of placing information concerning SL in said header.

13. An interconnect structure S having a plurality of input ports including the input port IP and a logic RP and a plurality of output ports including the output port OQ with there being a buffer OB associated with OQ with said buffer containing a set B of bins with each member of said set B being contained in the buffer associated with OQ and for a message packet MP arriving at IP, the logic RP designating a bin MB of B so that MP will be placed in MB.

14. An interconnect structure S in accordance with claim 13 in which the message MP has a header and there is a method for placing information concerning MB in the header of MP.

15. An interconnect structure in accordance with claim 13 in which the message packet MP is divided into segments and a plurality of the segments of MP are directed to a common bin MB.
